(19) United States
(12) Patent Application Publication
(10) Pub. No.: US 2005/0201574 A1
(43) Pub. Date: Sep. 15, 2005

(54) Method and apparatus for improving hearing in patients suffering from hearing loss

(75) Inventor: Martin L. Lenhardt, Newport News, VA (US)

Correspondence Address: Heller Ehrman White & McAuliffe LLP;Suite 300, 1666 K Street, N.W., Washington, DC, 20006, US

(73) Assignee: SOUND TECHNIQUE SYSTEMS, Newport News, VA (US)

(21) Appl. No.: 11/037,468

(22) Filed: Jan. 19, 2005

Related U.S. Application Data
(60) Provisional application No. 60/536,987, filed on Jan. 20, 2004.

(51) Int. Cl. H04R 25/00

(52) U.S. Cl. 381/151; 381/370

(57) ABSTRACT

Methods, apparatus and systems for treating sensrineural hearing loss include applying high frequency to ultrasonic frequency vibration stimulus to the head or neck of a patient for a suitable period of time. Hearing and sound discrimination are improved by stimulating the patient's cortices leading to stimulation of cortical neurons to increase sensitivity to high frequency sound. Stimulus signals may be applied by bone conduction via transducers attached to the head or neck, or by airborne conduction via headphones, or by a combination thereof. Stimulus signals may be recorded and may be remotely produced and transmitted via a telecommunications link to a receiver in a remote location. A compact auditory stimulation device includes electronics for storing a personalized stimulus signal, sound generators to produce the stimulus, a microprocessor, and a vibrator, such as headphones. Audiometer functions may be included in the auditory stimulation device to permit testing of the patient's hearing level thresholds.

This application claims priority to U.S. Provisional Application No. 60/536,987 filed Jan. 20, 2004, the contents of which is incorporated herein by reference in its entirety.

### BACKGROUND OF THE INVENTION

1. Field of the Invention

The present invention relates to a system and method for improving the threshold hearing sensitivity and discrimination ability of an individual. In particular, the present invention relates to a system and method for improving threshold hearing and discrimination ability of an individual using high frequency signals to stimulate the cortical auditory and/or other neurons in the individual's brain.

2. Description of the Prior Art

Mild to moderate sensorineural hearing loss is a common affliction. Prior to the present invention, there has been no effective cure for such hearing loss, with current treatments being limited to the use of amplifying prosthetics, i.e., hearing aids. Sensorineural hearing loss refers to hearing loss that involves the sensory and neural components of the ear such as occurs in inner ear hearing losses.

Hearing loss is sometimes accompanied by tinnitis, which maybe defined as any ringing for which there is no external source. Tinnitis is considered a phantom sound which arises in the brain and not actually in the ears as it appears to subjectively. For example, a ringing, buzzing, whistling, or roaring sound may be perceived as tinnitis. Tinnitis can be continuous or intermittent, and in either case can be irritating to one who has such an affliction. Tinnitis has been successfully treated by applying ultrasound to the head of a patient as described in U.S. Pat. No. 6,394,969 to Martin L. Lenhardt, which is incorporated herein by reference.

Nevertheless, there is a need for an effective treatment for hearing loss, including the treatment of hearing loss that is accompanied by tinnitis, without the use of amplifying prosthetics. This need is achieved for the first time by the present invention.

### SUMMARY OF THE INVENTION

Various embodiments of the invention are directed to methods for improving the hearing of an individual by applying a vibration stimulus between about 2 kHz and about 5 MHz to the individual by means of a transducer (e.g., a piezo transducer) for a period of time, such as about one hour. This period may be set in advance or adjusted during treatment by a clinician or the individual. The method may be combined with the application of a sonic vibration stimulus between about 2 kHz and about 20 kHz to the individual by means of headphones placed on or near the ears. Alternatively, the vibration stimulus may be applied by means of headphones alone. Without being bound by any theory, hypothesis or putative mode of action, the vibration stimulation of the brain of the individual is believed to cause neural reprogramming of high frequency sensitive neurons, thereby improving threshold hearing sensitivity.

Various embodiments of the invention are also directed to methods for treating individuals having sensorineural hearing loss (i.e., partial sensorineural hearing loss), which include applying a transducer, such as a piezo transducer, to the individual's head or neck, and connecting the transducer to a vibration signal so as to provide a vibration stimulus between about 2 kHz and about 5 MHz to the individual for a period of time, such as about thirty minutes to about one hour. This period may be set in advance or adjusted during treatment by a clinician or the individual. Alternatively or in addition, headphones may be placed on, in, or near the individual's ears and connected to a sonic vibration signal so as to provide a sonic vibration stimulus including frequencies between about 2 kHz and about 20 kHz is applied to the individual for a period of time, such as one hour. This method of treatment may be repeated periodically as necessary to maintain the level of hearing improvement.

Various embodiments of the invention are directed to systems and devices for detecting and/or treating hearing loss by applying a vibration stimulus to an individual.

### BRIEF DESCRIPTION OF THE DRAWINGS

The above-mentioned object and advantages of the invention will become more fully apparent from the following detailed description when read in conjunction with the accompanying drawings, with like reference numerals indicating the same or like parts throughout, and wherein:

FIG. 1 is a block diagram of an auditory stimulator system for treating sensorineural hearing loss according to an embodiment of the present invention;

FIG. 2 is a block diagram of an alternative auditory stimulator system for treating sensorineural hearing loss according to an embodiment of the present invention;

FIG. 3 is a block diagram of an alternative auditory stimulator system for treating sensorial hearing loss according to an embodiment of the present invention;

FIG. 4 shows an exemplary transducer that may be used to provide vibration stimulation to the patient, so as to treat sensory hearing loss in accordance with an embodiment of the present invention;

FIG. 5A shows an exemplary embodiment of fluid filled headphones that may be used to provide vibration stimulation to the patient, so as to treat sensory hearing loss in accordance with an embodiment of the present invention;

FIG. 5B shows an exemplary embodiment of a fluid filled neck ring that may be used to provide vibration stimulation to the patient, so as to treat sensory hearing loss in accordance with an embodiment of the present invention;

FIG. 6 is a diagram showing a brain-sphere model used to determine resonant frequencies of a brain;

FIG. 7 a block diagram of a system for producing a stimulus signal according to an embodiment of the invention;

FIG. 8 is a composite graph showing the frequency hearing threshold response of four individuals exhibiting hearing loss but not tinnitis prior to receiving treatment according to an embodiment of the present invention;

FIG. 9 is a graph of the frequency of signal applied to individuals in a treatment according to an embodiment of the present invention;

FIG. 10 is a graph showing the measured change in hearing frequency threshold response of the four individuals of FIG. 8 receiving a treatment according to an embodiment of the present invention;

FIG. 11 is a graph showing the measured change in hearing frequency threshold response of the individuals of FIG. 10 receiving a treatment according to an embodiment of the present invention; and,

FIG. 12 is a diagram of a system for remotely treating sensorial hearing loss according to an embodiment of the present invention.

FIG. 13 is a system block diagram of another auditory stimulator system embodiment of the present invention;

FIG. 14 is a system diagram of an auditory stimulator system embodiment of the present invention;

FIG. 15 is a system diagram of a high frequency hearing testing assembly according to and embodiment of the present invention;

FIG. 16 is a graph illustrating the difference in hearing thresholds between air conduction and bone conduction at high frequencies;

FIG. 17 is a circuit diagram of a high frequency audiometer-to-transducer matching circuit according to an embodiment of the present invention;

FIG. 18 is a system block diagram of an integrated audiometer and auditory stimulator system according to an embodiment of the present invention; and

FIG. 19 is a system diagram of an integrated audiometer and auditory stimulator system according to an embodiment of the present invention.

### DETAILED DESCRIPTION OF EXEMPLARY EMBODIMENTS

Various embodiments of the invention are directed to methods, apparatus and systems for treating sensorineural hearing loss, particularly high frequency hearing loss. The incidence of sensory hearing loss tends to increase with age, thus affecting much of the population. Age, drugs and/or intense sound can permanently damage the hair cells within the ear that sense sound waves. Such damage often leads to a loss of high frequency stimulation in the cochlea, which leads to a reduction in the amount of neural signals (i.e., neural information) provided to the cortex. Such sensory hearing loss may be characterized by increases in the threshold volume at which an individual perceives tones at different frequencies. An example of a patient population suffering from such effects are those individuals exhibiting mild to moderate sensorineural hearing loss. Another example patient population are those suffer partial hearing loss and loss of frequency, time and intensity discrimination.

It has been shown that musicians exhibit expanded auditory cortex and related neural structures with musical training. This is the likely reason for their improved detection and discrimination of sound. Similarly, it has been found that a reduction in the amount of high frequency sound detected in the cochlea may lead high frequency-sensitive neurons to reprogram to be sensitive to lower frequency sound by shifting their best frequency response toward lower frequencies. It is believed that when there is high frequency hearing loss without tinnitis due to damage in the cochlea, auditory neurons reprogram to achieve best frequency responses below the band of frequency loss in the cochlea. Further, a reduction in high frequency neural signals received in the cortex may lead to changes in synaptic connections and/or a shrinking of the population of neurons processing high frequency sound. Such adaptive reprogramming of cortex neurons and reductions in the population of high frequency sensitive neurons in the cortex may lead to further high frequency hearing loss. References herein to reprogramming of neurons means the natural adaptation that neurons and neural structures exhibit in response to training, stimulation or lack of stimulation.

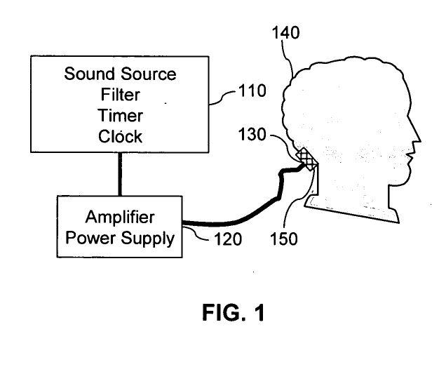

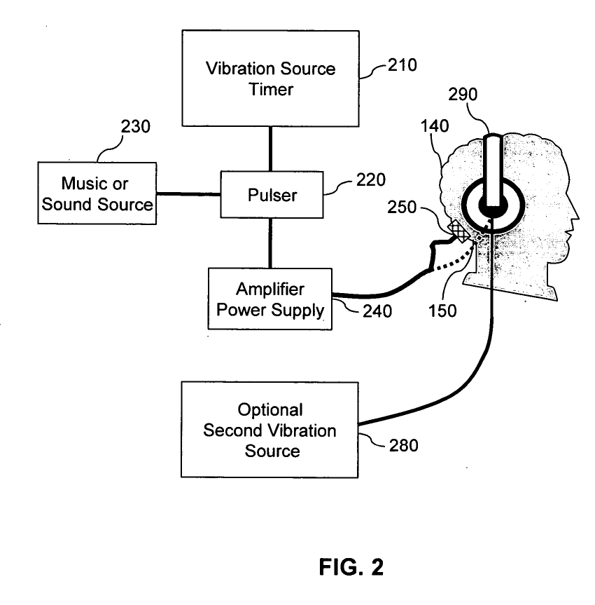

The present invention stimulates the cortex by applying high frequency or ultrasonic vibrations (approximately 2 kHz to approximately 5 MHz) to the head (neck or body) of an individual in order to prevent or reverse the deleterious programming of high frequency sensing and processing neurons to lower frequencies. As used herein, “vibration” encompasses periodic movement of a physical surface (e.g., the active face of a transducer) and/or a nongaseous fluid (e.g., water or blood) that when placed in contact with the head of an individual are sufficient to induce pressure pulses within the cochlea and/or the brain of the individual. A single tone vibration may be characterized in terms of its frequency (i.e., a vibration has a frequency) and amplitude (e.g., volume). Further, a vibration stimulus may comprise the combination two or more vibration frequencies, such as two or more tones or chords, e.g., music. A vibration stimulus applied to the skin may be perceived as a vibration or as an audible sound for high frequency signals or may be inaudible ultrasound. Such vibrations are referred to herein as “stimulus” or “vibration stimulus.” Block diagrams of exemplary systems suitable for applying such stimulation to individuals are shown in FIGS. 1 and 2.

Vibration stimulus applied to the head or neck of an individual according to various embodiments of the present invention is believed to lead to reprogramming of cortex neurons that resets their best frequency response. It is possible that such reprogramming occurs neurochemically by changing inhibitory inputs to cortical cells. Consequently, the simulation is believed to cause adaptive cortical neural reprogramming, which may be referred to as cortical reorganization or remapping, that leads to improved sensitivity to high frequency sound and discrimination (i.e., the ability to detect high frequency sound at lower threshold volume). Further, it is believed that such reprogramming occurs rapidly, taking place within less than 1 day, likely within approximately 1 to 3 hours, and possibly as rapidly as within 5 to 35 minutes, approximately.

The present invention also may simulate the cilia of hair cells within the cochlea, and also the vestibular system; canals, utricule and/or saccule. It appears that vibration stimulus in the form of high frequency noise or ultrasound applied to the head of an individual is demodulated in the cilia of hair cells due to the ultrasonic resonance of the cilia. Thus, movement of endolymph caused by a compressive intracochlear ultrasonic wave may induce vibration of the cilia at their ultrasonic resonance. This may have rejuvenative effects on the hair cells by way of the direct stimulation. Further, stimulation of nearby hair cells that may not be damaged may also stimulate adjunct areas in the central nervous system, which may send additional stimulating signals to the cortex.

Treatments according to various embodiments of the present invention may be repeated periodically. Since it is believed that hearing threshold and discrimination improvements result from reprogramming of neurons in the cortex and/or rejuvenation of hair cells and neurons in the cochlea, periodic repetition is expected to increase the effectiveness and lasting benefits of the treatment. Further, periodic treatment may be effective in preventing or reducing the reprogramming of high frequency sensitive cortical neurons that occurs due to reduced stimulation provided by damaged high frequency hair cells in the cochlea. Additionally cortical cochlear feed forward and feed back networks may modulate the receptiveness of the ear and brain.

Since high frequency sensory hearing loss may have its roots in degenerated or damaged high frequency hair cells within the cochlea, listening to high frequency sound, referred to herein as “airborne conduction,” may not provide sufficient stimulation to cause reprogramming of neurons and training of the cortex to detect high frequency sound. To address this physical limitation, various embodiments of the present invention provide vibration stimulus to the cochlea and/or cortex by applying high frequency and/or ultrasound vibration energy directly to the head or neck of an individual in a manner that induces conduction through the bones and/or fluids (e.g., blood, muscle, brain tissue, etc.). Vibration stimulus may be applied to the individual by placing a transducer in direct physical contact with the scalp or skin. Alternatively, vibration stimulus may be applied through nongaseous fluids (e.g., water) in direct contact with the individual's head, neck and/or ears. It is believed that vibration stimulus so applied is provided into the individuals brain and/or inner ear by conduction through bones of the head (referred to as bone conduction), through fluids (e.g., blood) and tissues (e.g., muscle, brain tissues) of the head and neck (referred to herein as fluid conduction), or through both bone conduction and fluid conduction.

Mild hearing loss and noise exposure is often accompanied by tinnitis. Tinnitis can be described as a phantom sound (e.g., whistling, buzzing, ringing, etc.) that arises without any external stimulation. Often the source of tinnitis is assigned to the ear by an individual because it “sounds” like a sound in that it has the pitch, loudness and timbre of a sound. Tinnitis can be matched in quality to an external sound, and it is often associated with one ear or the other, or both ears.

There are researchers who pose a central origin to tinnitis, with that central origin being beyond the ear and in the brain. For example, an article by Lockwood et al., published in 1998, found widespread activation of the primary cortex contralateral to the ear as being the source of tinnitis. In other words, the source of tinnitis may actually be cortical and not in the ear. Similarly, in “Ultra-High Frequency Acoustic Stimulation and Tinnitis Control: A Positron Emission Tomography Study,” The International Tinnitis Journal, Vol. 10, No. 2, 2004, pp. 113-126, Lenhardt, et al. found activation of the primary cortex and other sites within the brain as the source of tinnitus. This is a reasonable view since it has been demonstrated that auditory cortical neuron reprogramming in the ear is not capable of providing frequency-specific stimulation. Further, Lenhardt et al. reported that ultra-high-frequency external acoustic stimulation quieted brain activity in the sites of tinnitus. Thus, the reprogramming of the cortex in response to high frequency signal deprivation due to loss or damage of high frequency sensitivity of cochlear hair cells may well produce tinnitis as a by-product.

This view is supported by position emission tomography (PET) scans of individuals with tinnitis. The neural imaging data show that tinnitis activates the primary auditory cortex contralateral to the ear in which the tinnitis is localized, with that area activated being broader than that activated by sounds of similar frequency.

While there may be disagreement about the site of tinnitis (ear versus brain), most researchers agree that tinnitis and hearing loss often are associated. Therefore, the treatment of mild to moderate high frequency hearing loss should also address tinnitis associated with that hearing loss. Further, since a treatment that also suppresses tinnitis would remove the tinnitis noise that tends to impede perception of high frequency sound, treatments according to various embodiments of the present invention are expected to provide even greater improvements in threshold hearing sensitivity of patients with both hearing loss and tinnitis.

To determine a treatment for sensorineural hearing loss and potentially associated tinnitis, one has to understand the workings of the inner ear and the brain. External sounds activate both primary cortices, and each cortex is connected to a respective ear via a descending auditory nervous system. When auditory stimulation is applied using air conduction alone, the brain will actively try to reduce the amount of auditory stimulation arising up the auditory pathway by activating the descending auditory neural track. The result is that the brain will try to turn down the auditory stimulation, limiting the effectiveness of treatments using air conduction in stimulating cortical neurons. Further, energy from sounds above the middle ear resonance frequency, which is on the order of 3,000 Hz, are impeded within the middle ear due to interference from reflected waves. As a result, what is needed is a stimulus that is sufficiently salient to stimulate the high frequency responsive neural structures of the cortex and/or cochlea, but is not treated as an unwanted sound signal that will be inhibited by the brain. A stimulator that provides such a stimulus will be effective in terms of auditory cortical activation. Such a stimulator will be effective with individuals having hearing loss due to degraded cochlear hair cells. Such a stimulator will also be effective in treating individuals having hearing loss and associated tinnitis.

High frequency or ultrasonic noise or tones provide a stimulus that will meet all of the above criteria, and therefore can be used in the systems and methods for treating sensorineural hearing loss according to various embodiments of the invention. Such noise or tones can be made up of any part of the spectrum from about 2,000 Hz up to about 200,000 Hz (approximately 2-200 kHz). In various embodiments, the ultrasonic noise band may extend from about 2,000 Hz to about 20,000 Hz (approximately 2-20 kHz), from about 6,000 Hz to about 16,000 Hz (approximately 6-16 kHz), or from about 8,000 Hz to about 14,000 Hz (approximately 8-14 kHz). In another embodiment, vibration stimulus in a frequency band of from about 200,000 Hz (200 kHz) to about 5 MHz may be used, with or without the other ranges in the aforementioned embodiments. Alternatively, single or multiple tones in the ranges provided in the aforementioned embodiments may be used instead of noise. In another embodiment, a single tone or noise (e.g., pseudo-randomly varying tones) in a range of from about 2 kHz to about 20 kHz may be used, whereby this frequency range corresponds to an upper audio frequency range. In each of the aforementioned vibration stimulus frequency ranges, the tonal or noise stimulation may be applied directly to the head or neck of an individual such as via a transducer placed in direct contact with the skin or scalp, via a fluid in contact with the skin or scalp, or alternatively in combination tones or noise applied via both a transducer and via a fluid in contact with the skin or scalp. As used herein, the term “about” in the context of numerical values and ranges refers to values or ranges that approximate or are close to the recited values or ranges such that the invention can perform as intended, such as having a desired degree or extent of cochlear and/or cortical stimulus, as is apparent from the teachings contained herein. Thus, this term encompasses values beyond those simply resulting from systematic error.

The spectral energy that may be applied to an individual to treat sensorineural hearing loss is from about 2 kHz upward and can be a single tone, multiple tones or filtered noise. Further, it can be continuous or pulsed, and/or modulated with an audible signal such as music. The spectral energy is preferably delivered near or at no more than about 20 dB or so above the individual's threshold hearing level (e.g., between threshold and 20 dB above threshold).

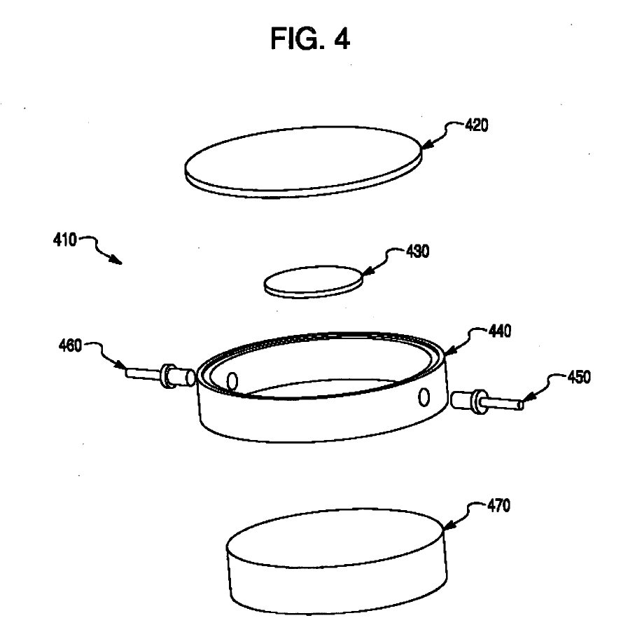

Under various embodiments of the present invention, delivery of vibration stimulus to an individual may be by a vibrator placed directly on the skin of the head or neck of the individual receiving treatment. As used herein, a vibrator is a device for applying audio range to high frequency vibrations to an individual directly, such as directly to the skin, or indirectly, such as via an intermediary fluid like water or via the air conduction (i.e., sound). One embodiment of a vibrator is a piezoelectric transducer, such as transducers similar to those used in transcranial Doppler insonation. By way of example but not by way of limitation, a suitable transducer is illustrated in FIG. 4 which is described more fully below.

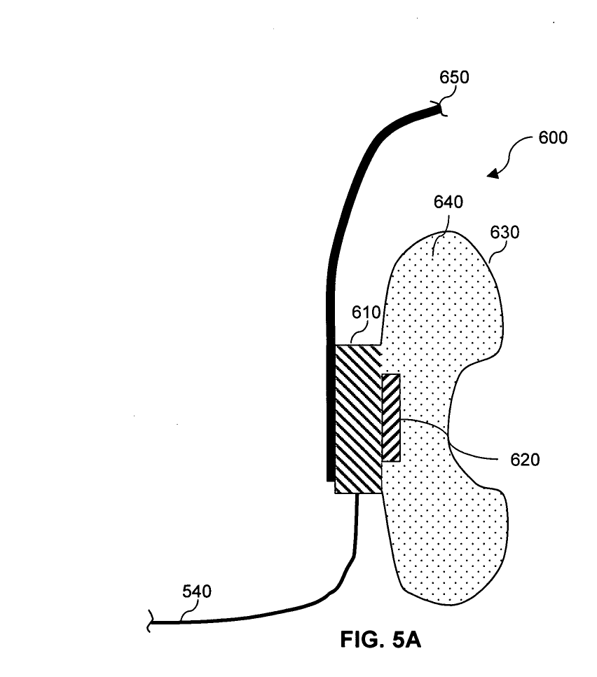

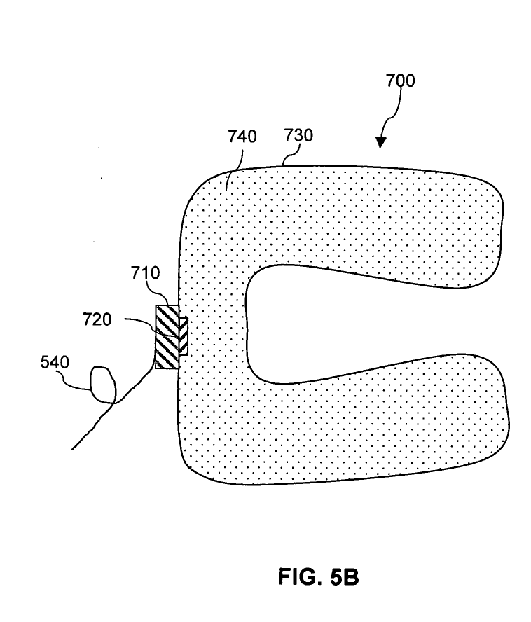

Under various embodiments, delivery of vibration stimulus to an individual may be via a vibrator featuring fluid placed in contact with the head or neck of the individual receiving treatment. As but one example, a portion of the patient's head, such the back of the head up to and potentially including the ears, may be placed under a fluid, such as water, in which a transducer is submerged. The relatively strong vibrational coupling between a fluid, such as water, and the patient's tissues will result in a large fraction of the vibration energy being transmitted into the patient's head. In various embodiments employing fluidic coupling of vibration stimulus to the patient, fluid filled earphones such as shown in FIG. 5A may be worn over the ears or fluid filled neck ring such as shown in FIG. 5B to conduct vibration stimulus via the fluid to the skin and bones surrounding the ear.

In the case where MHz tonal or noise frequencies are used according to an embodiment of the invention, the stimulus may be provided in a pulsed manner. The rate of pulsing is not critical, but a slow rate of pulsing, such as a rate from about 1 to about 10 Hz, is preferred. Because the stimulator according to various embodiments of the invention is high pitched and broad in spectrum, the high frequency sensitive area of the cerebral cortex will be stimulated. Since the delivery intensity will be low, the minimal energy (i.e., threshold) auditory sensitivity of an individual receiving such treatment will be improved. Since ultrasound is difficult to detect by air conduction, the stimulator according to various embodiments of the invention may be personal and inaudible to others who may be nearby the person undergoing treatment. A MHz pulser, to be used to deliver MHz noise signals according to the third embodiment, will preferably be delivered to the skin over the foreman magnum (back of skull by the neck).

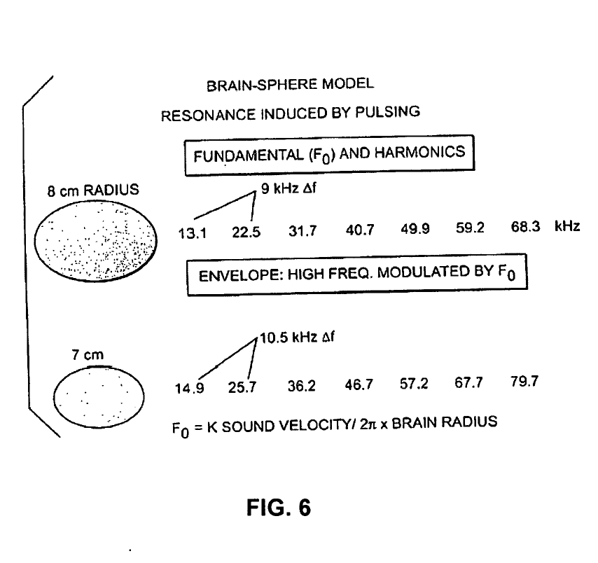

High frequency and ultrasound signals applied to the head or neck affects not only a wide area in the ear (sending afferent information to the auditory cortex), but they also affect the brain itself. Ultrasound actually pulses the brain since the brain's fundamental resonant frequency is in the low ultrasonic range to the high audio range (determined by the diameter of the brain and sound velocity in water). FIG. 6 shows a brain sphere model used to compute the brain's fundamental resonant frequency for two differently-sized brains. Further details on brain sphere models for calculation resonant frequencies of the brain are provided in “Ultrasonic Hearing in Humans: Applications for Tinnitus Treatment”, M. Lenhardt, International Tinnitus Journal, Volume 9, No. 1 &2, 2003, pp. 69-75, the contents of which are incorporated by reference in their entirety. The computation of the brain's fundamental resonant frequency is based on the model of the brain as a sphere with the skull as a boundary. As a result, a number of resonant frequencies will be generated when the brain is pulsed. Thus, ultrasound (frequencies above about 50 kHz up to about 5 MHz) applied to the head or neck of an individual will be modulated within a patient's head toward the resonant frequencies of the brain, which will be in the range of about 2 kHz to about 20 kHz. Accordingly, stimulation of brain structures, including the cortex, in the high frequency range may be accomplished directly by applying a high frequency sound or vibration to the head of an individual via a transducer, fluid filled headphones or fluid filled neck ring, or indirectly by applying an ultrasound (e.g., approximately 50-200 kHz) vibration to the head or neck via a transducer, fluid filled headphones or fluid filled neck ring.

Pulsed ultrasound noise according to an embodiment will also send the brain into oscillation at its resonant frequency, and thus is also a viable means of stimulation according to an embodiment of the present invention. Delgado and Monteagudo (1995) demonstrated that low frequency amplitude-modulated (AM) ultrasound can effectively stimulate cortical neutrons, which may be used to stimulate brain tissues for brain modification. The present invention also stimulates cortical neurons, but for the purpose of inducing neural reprogramming to improve the perception of high frequency sound, which was not recognized by Delgado and Monteagudo.

Therefore, various embodiments of the present invention provide for the use of high frequency or ultrasound to treat sensorineural hearing loss by stimulating any remaining high frequency area in the ear and by acting on cortical auditory neurons in the brain. Thus, the various embodiments of the present invention deliver high frequency or ultrasonic energy occipitally to the patient, thereby stimulating the high frequency areas of the cochlea and cortices. Other embodiments make use of direct stimulation via bone conduction to provide a high frequency audiometer that overcomes problems posed by ear canal acoustics and provides measurements suitable for designing personalized treatments for high frequency hearing loss.

FIG. 1 shows a block diagram of an apparatus for treating sensorineural hearing loss according to various embodiments of the invention. In FIG. 1, a vibration source unit 110, which may include filters, timers and clocks, produces filtered noise vibration signals (over a range of frequencies) or one or more single frequency tones. In a first embodiment, the ultrasonic energy is presented as an amplitude modulated carrier that can be set at any discrete frequency from about 2 kHz to about 20 kHz. The range can be set to any discrete frequency from about 1 kHz to about 200 kHz in a second embodiment, anywhere from about 200 kHz to about 5 MHz in a third embodiment, and anywhere from about 10 kHz to about 20 kHz in a fourth embodiment. The carrier also may be swept over the entire range or part thereof. The carrier may be multiplied by an audio tone in the range of from about 1 kHz to about 20 kHz. This corresponds to a carrier modulated by an audio tone. The audio tone can also be presented over a small range or swept through the entire range of audio frequencies. Sweep time is variable, and preferably is set to a range of from about 2 to about 3 minutes. The above described flexibility in the carriers and audio frequencies allows an operator to set frequency parameters such that the end result is proper stimulation over the ultrasonic range of from about 2 kHz to at least about 20 kHz. Speech or music also may be employed as part of the audio frequencies multiplied by the high frequency carrier signal. These sound sources are administered via bone conduction and/or fluid conduction from a vibrator, such as a transducer, applied to the head of an individual, or fluid filled headphones or a fluid filled neck ring applied to the head of the individual, or alternatively by a combination of both a transducer and fluid filled headphones as illustrated in FIG. 2.

Another embodiment uses an amplitude modulated carrier signal that is solely in the upper audio range in order to provide high frequency stimulation to an individual. This embodiment has an advantage in that, due to the use of a lower frequency range, the power consumption is less than it is for the other frequency ranges used in other embodiments. In this embodiment, the treatment signal may be provided to the patient via fluid filled headphones or a fluid filled neck ring, either alone or in combination with a transducer applied to the head or neck. Since the high frequency sound detected in the cochlea will result in stimulation of the high frequency neurons within the cortex, leading to neural reprogramming, this embodiment may have similar beneficial effects on threshold hearing sensitivity. This conclusion is supported by recent tests on mammals (ferrets) that noted changes in cortical neural structures following training with high frequency signals, as reported in The Acquisitive Auditory Cortex by John C Middlebrooks and Rapid Task-Related Plasticity of Spectrotemporal Receptive Fields in Primary Auditory Cortex by Jonathan Fritz, Shihab Shamma, Mounya Elhilali & David Klein, published in Nature Neuroscience Vol. 6, No. 11, 2003, pages 1122-23 and 1216-1223, respectively.

In one or more embodiments, signal transmission is by way of double sideband modulation (suppressed carrier). Full amplitude modulation (full AM carrier plus both sidebands) or single sideband modulation (either upper or lower sideband with the carrier and the other sideband suppressed) can alternatively be utilized. Modulation depth generally does not exceed about 90% though a modulation of up to about 100% can work under ideal conditions, and the energy does not exceed about 15 kPa (measured in water at 3.5 cm). Total power is preferably limited to about 30 mW cm². Commercially available piezoelectric transducers may be used to deliver the ultrasound in vibratory form to the patient's head or to a fluid in contact with the patient's head. The precise level of energy (not to exceed about 15 kPa) may be determined for each patient during testing of each patient, or based upon predetermined values. Ultrasound signals may or may not be audible during therapy. Sound pressures may be maintained at or below comfortable listening levels and in compliance with federal safety standards on sound exposure.

Referring back to FIG. 1, the sound source unit 110 may include a filter for producing filtered noise, a timer, and/or clock. These elements can operate as a pulse filter for ultrasonic noise, with the timer or clock providing the pulse timing. The output of the sound source unit 110 is provided to an amplifier and power supply unit 120, which amplifies the signal to the proper level to provide a signal to the patient at the low, minimal energy, as previously explained. A transducer unit 130 converts the output of the power supply unit 120 to a vibration, which is felt by the patient. The transducer unit 130, which may be a piezoelectric device, is placed somewhere on the patient's head 140 or neck 150, preferably just behind the ear. Vibrations are provided to the brain (not shown) within the skull of the patient's head 140, thereby stimulating the cortices.

FIG. 2 shows an alternative embodiment for delivering ultrasound noise or tones to the head or neck of an individual while simultaneously delivering vibration stimulus via fluid conduction. Referring to FIG. 2, an ultrasound tone generator 210 provides a tone, such as a tone in the kHz to MHz range. The output of the first tone generator 210 is provided to a pulser 220, which provides pulses of MHz noise at a predetermined rate, for example, between about 1 and about 10 Hz rate. In an embodiment, the pulser 220 forms pulses, such as by modulating the kHz to MHz noise or tone with a audible sound between, for example, about 1 and about 10 Hz supplied by sound source 230. Sound source 230 may provide an audible tone, noise or sound. Output from the pulser may be amplified by amplifier/power supply 240 to provide sufficient power to drive a transducer 250 or other suitable vibrator. Output from the amplifier 240 is directed to a transducer 250 that is situated on the patient's head 140 or neck 150, preferably in direct physical contact with the skin on the back of the skull by the neck. FIG. 2 also shows the optional delivery of a vibration stimulus via a vibrator that features fluid placed in contact with the patient's head, for example via fluid filled headphones 290. Fluid filled headphones may be connected to the output from the amplifier 240 to provide the same vibration stimulus. Alternatively, fluid filled headphones 290 may be connect to the optional second vibration source 280. In FIG. 2, the optional second vibration source 280 is shown including a vibration source unit, amplifier and power supply unit within the same box. The optional second vibration source 280 may also include filters, timers and other electronics. The optional second vibration source 280 may provide stimulus of a different vibration frequency than vibration source 210 to permit multi-frequency treatments. The optional second vibration source 280 is illustrated coupled to a means for providing the vibration stimulus to the individual via fluid conduction by means of fluid filled headphones 290. Fluid filled headphones 290 are positioned on, in or near the patient's ears to provide the vibration stimulus to the bones and fluids surrounding the ear. As discussed further below, the vibration stimulus provided by vibration sources 210 and/or 280 may modulate high frequency or ultrasound tone or tones with a pleasing sound such as music to produce a more pleasant stimulus. As another alternative, the fluid filled headphones 290 may be replaced with a fluid filled neck ring (not shown) as described more fully below.

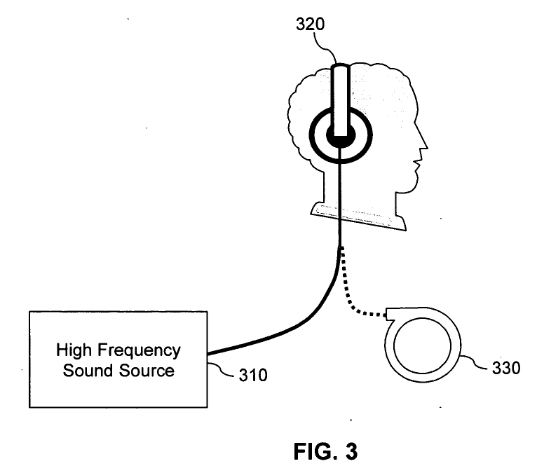

FIG. 3 shows an alternative embodiment for delivering the vibration stimulus via fluid filled headphones only. In this embodiment, a tone generator or vibration source 310 provides a tone, noise or sound between about 2 kHz and about 200 kHz, more preferentially between about 2 kHz and about 20 kHz. The output of the vibration source 310 is applied to the patient by fluid filled headphones 320. Fluid filled headphones 320 are positioned on, in or near the patient's ears. The vibration source 310, which generates noise or tones in the range of from about 2 kHz to about 200 kHz, includes the sound source unit, amplifier and power supply unit. The vibration source 310 may further include filter, timer and clock electronics. As an alternative to this embodiment, the fluid filled headphones may be replaced with a fluid filled neck ring such as described herein.

A further embodiment of the invention employs music as part of the vibration stimulus, which may be in the form of pulsed vibration stimulation. Within the vibration source 310, a music signal may be filtered, and then multiplied by a high or ultrasound frequency vibration signal, which corresponds to a carrier having a frequency value within the range of from about 2 kHz to about 200 kHz. The carrier may be tonal (e.g., one or more single frequency tones between about 10 kHz and about 20 kHz), noise (e.g., white noise between about 2 kHz to about 20 kHz), or a swept carrier in the frequency range from about 2 kHz to about 200 kHz, more preferably between about 5 kHz to about 20 kHz. The music may be pulsed in such a fashion as to be culturally agreeable to the listener, since music is (typically) meant to be enjoyed when heard. The output signal, which is the filtered music multiplied with the carrier (or plurality of carriers, if more than one tone is used) in the range of from about 2 kHz to about 20 kHz, may not be recognizable as music, but the output signal has the temporal essence or timbre of music.

In an alternative implementation of this embodiment described above, the stimulus signals are recorded on a suitable recording device or medium, such as by way of example but not by way of limitation, a digital or analog magnetic tape, video cassette recorder (VCR) tape, magnetic disc, compact disc (CD), digital video disc (DVD), an MP3 player or a player using other compression algorithms, a computer hard drive, a disk drive of a server computer hosting an Internet website, random access memory (RAM), read only memory (ROM), flash memory or erasable programmable read only memory chips, or other electronic, magnetic and/or optical storage device or technology that will be developed in the future, with segments, files or tracks varying in intensity level. Using a CD as an example, the listener may adjust the volume of the stimulation by selecting the appropriate track of the CD.

Referring to FIG. 3, a relatively inexpensive embodiment includes a CD player 330, or alternatively a portable tape or MP3 player (not shown), and fluid filled headphones 320, plus the CD containing the stimuli. As an alternative to fluid filled headphones, transducers may be held in contact with the head or neck of the wearer such as by mechanical force applied by the headphone bracket assembly. This embodiment enables treatment of the patient virtually anywhere, e.g., at work, at home, etc. In an implementation of this embodiment, the tracks on a CD may provide the stimulation with increasing volume levels in approximately 1 dB increments. For example, tracks ranging from about −54 dB to about 0 dB may be provided in 6 dB steps (approximate) on a single CD. Preferably, each track is of a duration of about 1 minute and 25 seconds which can be, looped for longer play time. Other track durations are possible while keeping within the spirit and scope of the invention, and track durations from as low as tens of seconds to as much as one hour or more, are contemplated. A standard commercially available CD player 330, tape or MP3 player (not shown) and/or the like may be used to provide such treatments. In this example, all the user needs to do is to put the CD with the stimulus signals according to the present invention into a CD player 330, or record the signals from the CD to an MP3 player (not shown), and then put on the headphones 320. When the user turns the player on to a particular track or segment, the treatment begins. Treatments according to this embodiment may be useful to maintain or enhance the benefits of treatments provided according to other or the aforementioned embodiments of the present invention and/or to prevent or reduce the reprogramming of high frequency sensitive cortical neurons toward low frequencies that may result from damage to high frequency cochlear hair cells. As another alternative, the fluid filled headphones 320 may be replaced with a fluid filled neck ring (not shown) as described more fully below.

Low frequency stimulus signals can be combined with ultrasound stimulus by amplitude modulating the ultrasound signal by very low audio frequencies, for example, from about 1 Hz to about 50 Hz. The perception of such a stimulus is of high pitch sound having a low frequency periodicity. The periodicity can be increased or decreased by changing the modulating audio frequency. Thus, using an apparatus and methods according to various embodiments of the invention, the ultrasound treatment for high frequency hearing loss can be tuned to also provide low frequency stimulation, which may be beneficial for also treating or suppressing low frequency tinnitis often seen with the hearing loss. Further, auditory nerve low frequency synchronous firing stimulation may also be incorporated in the ultrasound treatment regime according to various embodiments of the invention.

A site of action of the treatments according to various embodiments of the present invention appears to be the hair cells in the inner ear when a MHz amplitude modulated signal is applied, in which an audio tone is reintroduced by demodulation. In the ultrasound stimulus methods and apparatus according to various embodiments of the invention, demodulation does not appear to take place in the cochlea, but instead, the site of action appears to take place in the cilia of the hair cells. The cilia have ultrasonic resonance, and a movement of endolymph by a compressive intracochlear ultrasonic wave may have rejuvenative effects on the cell directly. The effect may also occur in the vestibular system, which is also activated by ultrasound. Stimulation of nearby cells (with respect to those injured) may also stimulate adjunct areas in the central nervous system, thereby providing additional stimulation to neurons in the cortices.

FIG. 4 shows an exploded view of the separate components making up an example of a transducer 410 that can be utilized in any of the various embodiments of the present invention, in order to provide a vibration to a patient's head or neck to apply high frequency or ultrasound vibration stimulus by way of bone and/or fluid conduction. The components are shown in an exploded view as separately disposed from each other in FIG. 4 in order to provide a clear description of the transducer 410, whereby these components are coupled to each other to provide an integral transducer during a manufacturing process for making the transducer 410.

Referring to FIG. 4, the example transducer 410 includes an aluminum disk 420, a piezo (PZT) disk 430, an aluminum collar 440 (with a recess machined so as to receive the aluminum disk 420), a case ground solder pin 450, an insulated solder pin 460, and a foam rubber damping plug 470. Alternatively, the foam rubber damping plug 470 may be substituted with a cap made of vinyl or other suitable material. In a preferred construction of the transducer 410, the piezo disk is bonded to the aluminum disk 420 with silver bearing epoxy, the aluminum disk 420 is bonded into the recess of the aluminum collar 440 with silver bearing epoxy, a single solder wire (not shown) is soldered between the edge of the piezo disk 430 and the insulated solder pin 460, and the case ground solder pin 430 is coupled to the aluminum collar 440 using a swaging tool to ensure good electrical contact to the aluminum collar 440. The transducer 410 as shown in FIG. 4 corresponds to a Blatek 40 KHz air ultrasonic transducer. Other types of transducers, including commercially available transducers, may be utilized in the present invention in order to provide a vibration to the patient's head or neck by way of bone conduction.

In a configuration of the transducer utilized with the present invention, an oscillator (not shown) delivers a high ultrasound frequency, e.g., about 20 kHz frequency, at low level to the transducer 410. The high ultrasound frequency activates, or stimulates, the vibratory motion such that less energy is required at frequencies near the fundamental and first harmonic to produce a useful amount of displacement at the skin (e.g., approximately 1 micrometer displacement), than what would be required if the high ultrasound frequency was not provided to the transducer 410. Energy savings may be achieved using a 200 kHz tone in conjunction with the audio or low ultrasonic frequencies that are supplied in accordance with the present invention so as to mask or suppress tinnitis. Other high ultrasound frequencies besides 200 kHz may be utilized to achieve this energy savings (for example, using a high ultrasound frequency in the range of from about 100 kHz to about 500 kHz).

FIG. 5A shows an example of fluid filled headphones that can be utilized in any of the various embodiments of the present invention, in order to provide a vibration stimulus to a patient's head by way of bone and/or fluid conduction. The exemplary fluid filled headphones 600 illustrated in FIG. 5A include a housing 610 coupled to a transducer 620 that is vibrationally coupled to a fluid 640 contained within a flexible membrane 630. A U-shaped flexible bracket 650 is connected to the back of a first housing and extends over the head of a wearer and connects to the back of a second housing (not shown). Signals from a vibration source (not shown) are provided to the headphones 600 by an electrical conductor 540 or by means of a wireless data link (not shown) coupling the transducer 620 to a signal generator. Transducer 620 may be a transducer such as illustrated in FIG. 4 and described herein, or any suitable commercially available transducer. Fluid 640 may be any liquid suitable for conducting high frequency vibrations, including, for example but not by way of limitation, water, alcohol, oil, glycerin, suspensions, colloids, or solutions containing one or more of these constituents. The flexible membrane 630 is any material suitable for containing the fluid 640, including, for example but not by way of limitation, plastic, polyethylene, polypropylene, rubber, or similar material. Transducer 620 is vibrationally coupled to the fluid 640 by being positioned in contact with or within the membrane 630 so as to achieve efficient coupling of vibrations to the fluid 640. For example, vibrational coupling between the transducer 620 and the fluid 640 may be achieved by placing the transducer 620 within the fluid 640 (i.e., within the fluid boundary formed by membrane 630), or in direct physical contact with the exterior of membrane 640 (i.e., outside the fluid) so vibrations pass through the membrane into the fluid. Additional electronics such as batteries, control circuitry and/or amplifiers (all not shown) may be incorporated within the housing 610. The combination of the housing, transducer, membrane and fluid forms a single phone capable of transmitting vibrations when placed in direct contact with the skin of an individual. The housing 610 may be joined to the bracket 650 by any suitable structural connection, including a pivot, or alternatively, may be formed as a single piece comprising a U-shaped structure with housings on each end. Bracket 650 may include a spring-like structure to press the membrane 630 of each phone against the patient's head to assure good vibrational coupling between the fluid 640 and the patient's skin. When placed on a patient's head, such as over the ears, vibrations from the transducer 620 will be conducted via the fluid 640 and applied to the patient's skin through the membrane 630. Fluid filled headphones such as illustrated in FIG. 5A provide a portable and easy-to-apply means of conveying vibration stimulus to the head of a patient.

FIG. 5b shows an alternative vibrator in the form of a fluid filled neck ring that can be utilized in any of the various embodiments of the present invention, in order to provide a vibration stimulus to a patient's head by way of bone and/or fluid conduction. In this embodiment a fluid filled neck ring 700 illustrated in FIG. 5B includes a housing 710 coupled to a transducer 720 that is vibrationally coupled to a fluid 740 contained within a flexible U-shaped tubular membrane 730 that is in a form suitable for placement around or partially around the neck of an individual as a neck ring. Signals from a vibration signal source (not shown) are provided to the fluid filled neck ring by an electrical conductor 540 or by means of a wireless data link (not shown) coupling the neck ring to the vibration source. Transducer 720 may be a transducer such as illustrated in FIG. 4 and described herein, or any suitable commercially available transducer. Fluid 740 may be any liquid suitable for conducting high frequency vibrations, including, for example but not by way of limitation, water, alcohol, oil, glycerin, suspensions, colloids, or solutions containing one or more of these constituents. The flexible membrane 730 may be any material suitable for containing the fluid 740, including, for example but not by way of limitation, plastic, polyethylene, polypropylene, rubber, or similar material. Transducer 720 is vibrationally coupled to the fluid 740 by being positioned in contact with or within the membrane 730 so as to achieve efficient coupling of vibrations to the fluid 740. For example, vibrational coupling between the transducer 720 and the fluid 740 may be achieved by placing the transducer 720 within the fluid 740 (i.e., within the fluid boundary formed by membrane 730), or in direct physical contact with the exterior of membrane 740 (i.e., outside the fluid) so vibrations pass through the membrane into the fluid. Additional electronics such as batteries, control circuitry and/or amplifiers (all not shown) may be incorporated within the housing 710. The combination of the housing, transducer, membrane and fluid forms a neck ring that can be placed around the neck of an individual so the membrane 730 make contact with the neck and the base of the skull and or jaw. When placed on a patient's neck, vibrations from the transducer 720 will be conducted via the fluid 740 and applied to the patient's skin through the membrane 730. A fluid filled neck ring 700 such as illustrated in FIG. 5B provides a portable and easy-to-apply means of conveying vibration stimulus to the head of a patient.

An example of an embodiment utilizing music (or any complex acoustic pattern) to modulate a high frequency or ultrasound carrier signal to provide a treatment vibration stimulus, employs two tones used as the carrier signal, such as one at about 12 kHz and the other at about 16.384 kHz. Of course, other frequencies or number of tones may be chosen within an acceptable range (e.g., from about 10 kHz to about 20 kHz). Two frequencies may be chosen so as to better support music as an input signal. Music with an even spectral spread at a substantially constant volume may be preferable for use in this embodiment to provide an effective and more pleasing stimulus.

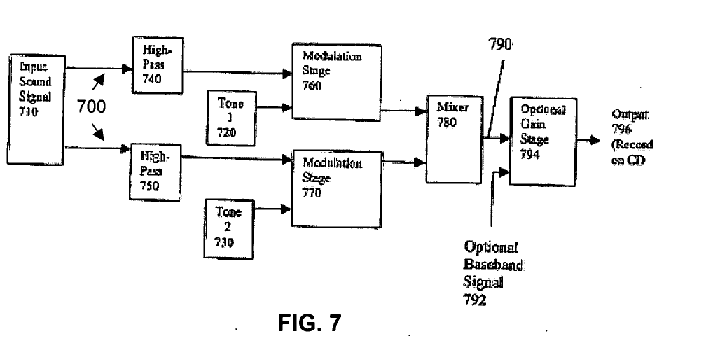

FIG. 7 shows a block diagram of a system for producing a vibration stimulus signal according to an implementation of various embodiments of the present invention. The input signal 700, which may be music, is multiplied independently with a first tone 720 and a second tone 730 after having first been filtered by an electronic high-pass filter (e.g., using 1 kHz high-pass filters 740, 750). The two filtered signals are routed through respective modulation stages 760, 770, one set about 20 dB lower than the other (this value is adjustable, and can be set to a different value, such as between about 10 to about 30 dB in gain difference). The two gain-adjusted signals, after having passed through their respective modulation stages 760, 770, are then mixed together by mixer 780, and then filtered by a high-pass filter (not shown) (e.g., an 8 kHz high-pass filter), to obtain a signal 790.

As an optional element, a final adjustable gain stage 794 may be utilized to mix in some unprocessed base band signal 792 with the signal 790, if desired. For example, a 200 kHz (approximate) tone can be mixed with the signal 790 at optional gain stage 794. The 200 kHz tone activates the transducer that receives the output signal, to cause the transducer to operate at one of its higher resonance frequency modes. This results in less energy in the lower frequency range (e.g., processed noise) to be detected by the patient. The use of such a high frequency tone may not be utilized in the embodiments that use air conduction to provide the treatment.

The final output signal 796 may be recorded onto a suitable signal storage medium which may include by way of example but not by way of limitation CD, DVD, magnetic tape, magnetic disc, VCR, random access memory (RAM), nonvolatile electronic memory (e.g., flash memory) in an MP3 player, and/or other storage medium or technology that will be developed, for playback through a transducer treatment device, fluid filled headphones or a fluid filled neck ring according to various embodiments of the invention.

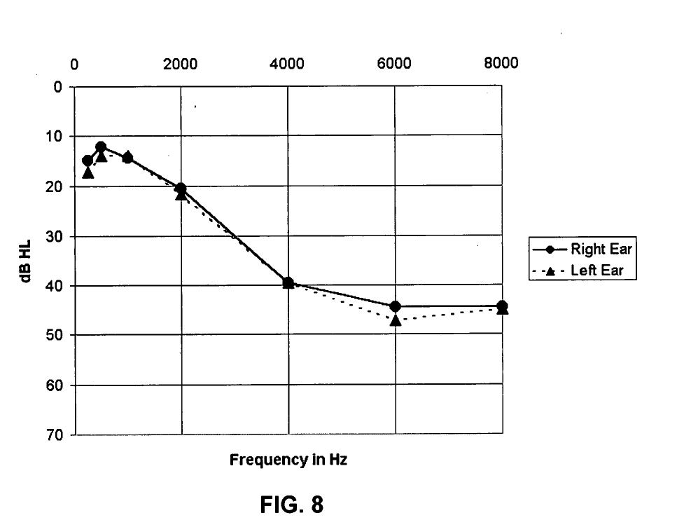

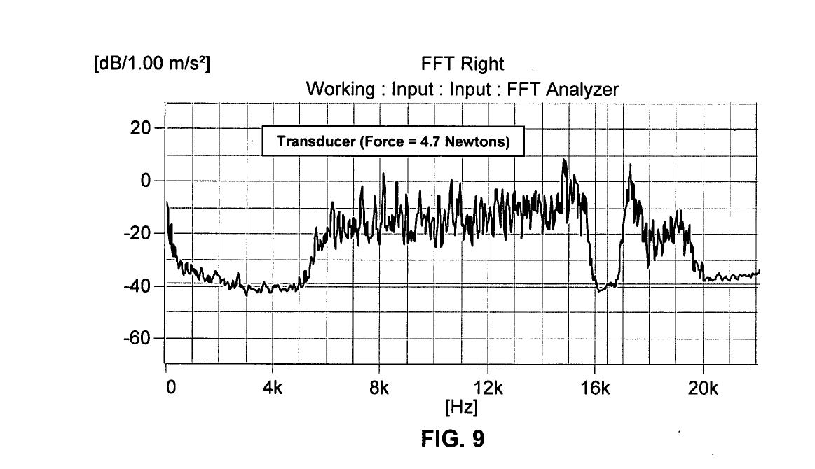

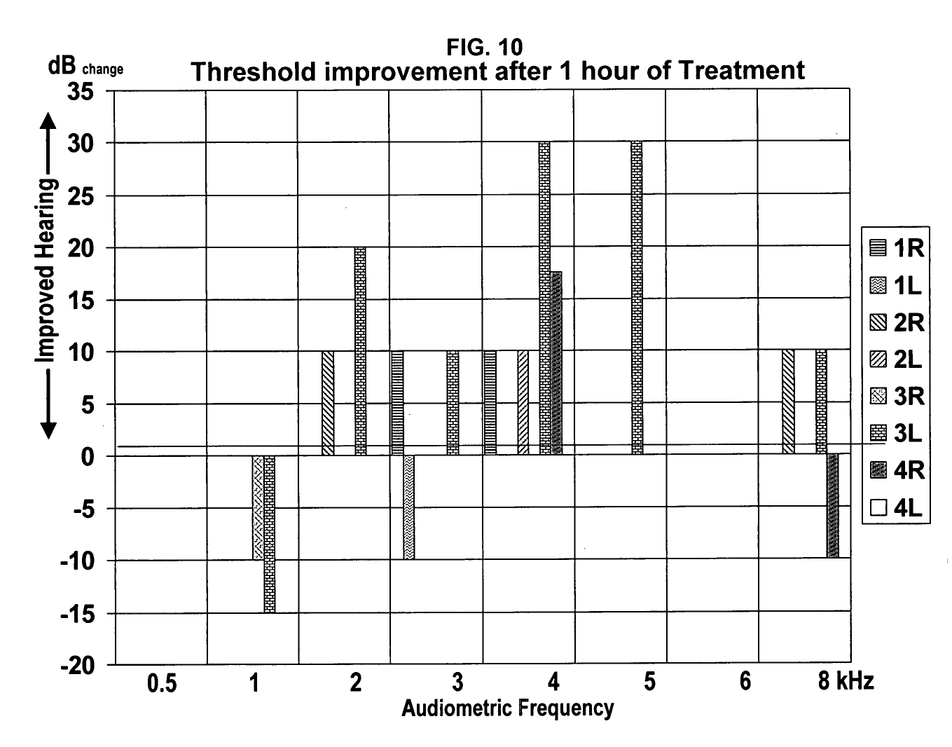

Tests were performed on volunteers to confirm the effectiveness of treating mild to moderate (i.e., partial) hearing loss in patients without tinnitis according to embodiments of the present invention. Four individuals exhibiting mild sensorineural hearing loss without tinnitis were first tested to determine their threshold hearing sensitivity over the auditory range. The composite results of this testing are shown in FIG. 8. These individuals were then subjected to a one-hour session of ultrasound stimulation according to an embodiment of the present invention using bone conduction stimulation at high frequencies (about 2-about 20 kHz) provided by a transducer applied to the head of the individuals. The amplitude spectrum of high frequency noise applied to these individuals is shown in FIG. 9. After receiving this treatment, the four individuals were retested for threshold hearing sensitivities. FIG. 10 shows the results of the retests in terms of changes in the threshold hearing levels as a function of frequency measured in dB. As can be seen from FIG. 10, all four individuals exhibited at least some improvement (10 dB to 30 dB) in threshold hearing sensitivity in at least one ear at mid to high frequencies. The test results shown in FIG. 10 also demonstrate that a hearing improvement is achieved after a single treatment lasting approximately one hour.

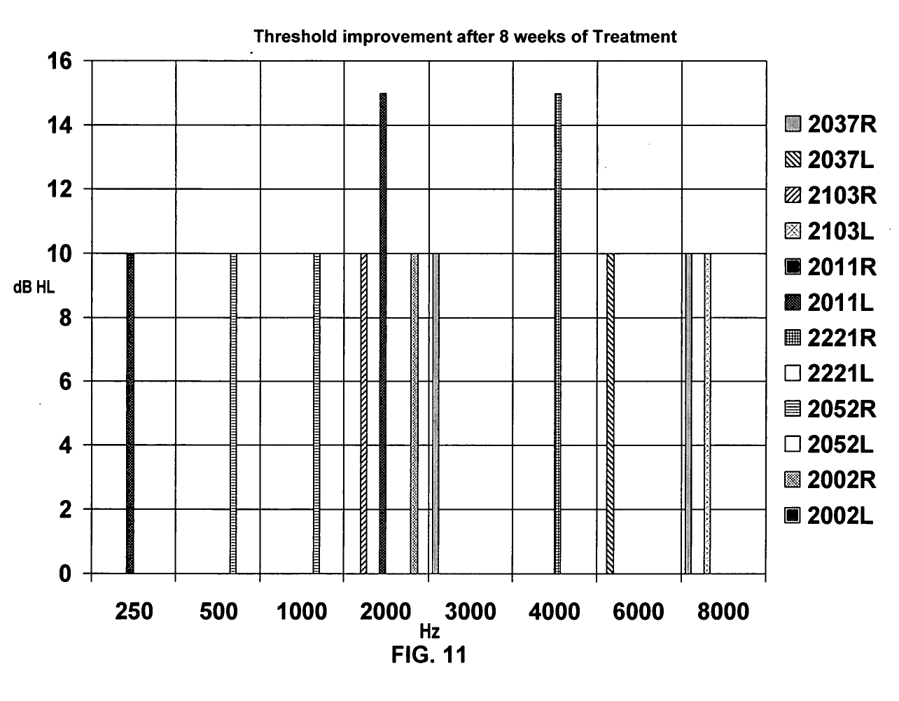

Tests performed using the present invention on individuals suffering from mild hearing loss and tinnitis were also conducted which demonstrated improvements in threshold hearing sensitivity. Moreover, by suppressing tinnitis, the hearing improvements afforded by treatments according to the invention are expected to be even greater for patients exhibiting both hearing loss and tinnitis. Specifically, six (6) individuals exhibiting mild sensorineural hearing loss and tinnitis were first tested to determine their threshold hearing sensitivity over the auditory range. These individuals were then treated twice per week for eight weeks with a one-hour session of ultrasound stimulation according to an embodiment of the present invention using bone conduction stimulation at high frequencies (about 2-about 20 kHz) provided by a transducer applied to the head of the individuals. The amplitude spectrum of high frequency noise applied to these individuals is shown in FIG. 9. After receiving this treatment, the six individuals were retested for threshold hearing sensitivities. FIG. 11 shows the results of the retests in terms of changes in the threshold hearing levels as a function of frequency measured in dB. As can be seen from FIG. 11, all of the test individuals exhibited at least some improvement (10 dB to 30 dB) in threshold hearing sensitivity in at least one ear at mid to high frequencies.

The apparatus and systems described herein are suitable for use in improving the hearing of an individual, particularly the threshold hearing of high frequency sound. Specifically, to improve the hearing of an individual, a vibration stimulus between about 2 kHz and about 5 MHz is applied to the individual, preferably to the head or neck by means of a transducer (e.g., a piezo transducer) applied to the skin or scalp for a period of time, such as about one hour to about three hours, preferably to approximately one hour or less and most preferably between about 35 minutes and about one hour. Alternatively or in addition, a vibration stimulus with frequencies between about 2 kHz and about 20 kHz is applied to the individual by means of fluid filled headphones or fluid filed neck ring placed on or near the ears.

The apparatus and systems described herein are also suitable for use in treating individuals having partial sensorineural hearing loss, particularly hearing loss in the high frequencies. Specifically, to treat a person having partial sensorineural hearing loss, a transducer, such as a piezo transducer, is applied to the individual's head or neck, and then a vibration signal is connected to the transducer so as to provide a vibration stimulus between about 2 kHz and about 5 MHz to the individual for a period of time, such as approximately one hour. Alternatively or in addition, fluid filled headphones or a fluid filled neck ring are placed on, in or near the individual's ears and connected to a vibration stimulus signal so as to provide a vibration stimulus including frequencies between about 2 kHz and about 20 kHz for a period of time. The period of time is up to about three hours, more preferably approximately one hour or less. This method of treatment using the described systems may be repeated periodically as necessary to maintain the level of hearing improvement.

While preferred embodiments have been described herein, modification of the described embodiments may become apparent to those of ordinary skill in the art, following the teachings of the invention, without departing from the scope of the invention as set forth in the appended claims. For example, the pulsing as described in one embodiment, may also be utilized in any of the other embodiments, so as to stimulate the brain at one or more of its resonant frequencies. Also, all of the components necessary to provide the treatment, may be accommodated on a single printed circuit board, to thereby make a small-sized treatment device, including portable devices that may be battery powered. A signal output from the printed circuit board may be stored directly on the board in random access memory (RAM), nonvolatile electronic memory, or on any form of digital storage medium or method that may be accessed by the device or a microprocessor, with may include by way of example but not by way of limitation a CD, DVD, magnetic tape, magnetic disc memory, VCR tape, electronic memory in a suitable format, such as for example digital MP3 format or other compression algorithms, and/or other storage technology that will be developed in the future, for playback on a device capable of accessing the digital storage medium, such as a CD player, magnetic tape player, or MP3 player coupled to headphones, a fluid filled neck ring or a suitable transducer to provide an inexpensive treatment for sensorineural hearing loss that may be applied in a doctor's office or at a patient's home or workplace.

In another embodiment, the vibration stimulus is stored in the form of vibration stimulus signals on a suitable random access memory (RAM), nonvolatile electronic memory (e.g., flash memory), optical, magnetic (e.g., magnetic tape or magnetic disc) or other storage media, including storage technologies that will be developed in the future. The stored stimulus signals may be retrieved by the appropriate storage media reading device or player, which may include by way of example but not by way of limitation, a CD player, a DVD player, a magnetic tape player, a magnetic hard drive, a VCR, a web-based server, laptop or notebook computer, an MP3 player or a player using other compression algorithms, a personal computer, a personal digital assistant (PDA) and/or other devices and technologies that will be developed in the future. Further, the appropriate storage media reading device or player may be coupled to a telecommunications system, cable, computer network, satellite telecommunications link, telephone link, wireless data link, or other data link to provide the stimulus signals to a remote location where they may be received on a suitable reception device, such as a cellular telephone, computer, laptop or notebook computer, PDA, radio, or other technology receivers for providing the stimulus signals to a transducer and/or fluid filled headphones or a fluid filled neck ring. The device player (e.g., CD player, DVD player, VCR, MP3 player, laptop or notebook computer, personal computer or PDA) may be used with or without a separate transducer disposed on the neck or head of the user to provide the stimulation treatment signals by way of bone or fluid conduction. In this embodiment, a doctor can provide access to the vibration stimulus signals by providing the individual with an individual prescribed (personalized) treatment stored on a signal storage medium, e.g., linear or non-linear storage media, a optical disc, CD, DVD, magnetic tape, VCR, magnetic disc, magnetic optical disc, random access memory (RAM), EPROM or other storage technology that will be developed in the future, the storage medium containing the signals that the individual can then use to receive treatment using an appropriate player device.

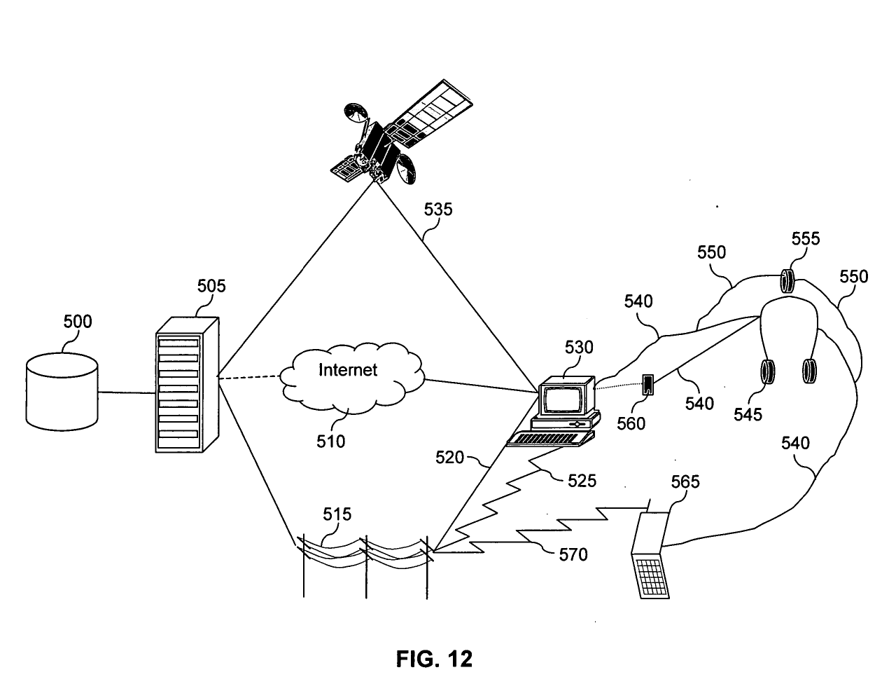

In another embodiment, the vibration stimulus is stored in the form of vibration stimulus signals on a suitable electronic, optical, magnetic or other technology storage media that will be developed in the future, with the storage media coupled to a computer accessible to the patient via a telecommunications system, such as, for example, a computer or web-based server hosting a website connected to the Internet. A system according to this embodiment is illustrated in FIG. 12. In this embodiment, the stimulus signals may be transmitted to patients by way of the telecommunications system or computer network, such as the Internet, an intranet or a wireless fidelity (WiFi) network, thereby enabling patients to obtain their treatment stimulus signal by accesses a particular web site, for example, and downloading the stimulus signals in a suitable electronic format for transmission and storage, such as in the form of an WAV or MP3 file. In one configuration of this embodiment, the stimulus signals may be played at the same time they are being downloaded (e.g., similar to a streaming audio service from the Internet). In this configuration, Internet access may also be provided by wireless communication means (e.g., cellular telephone or a WiFi network) to enable treatment anywhere such access is available. Alternatively, an individual's personalized stimulus signals (i.e., stimulus signals prepared or prescribed to treat the particular hearing loss of the individual) may be downloaded, such as after payment of a fee, and stored on a suitable recording media or storage device, such as for example but not by way of limitation, digital or analog magnetic tape, video cassette recorder (VCR) tape, magnetic disc, an MP3 or CD player, personal computer (storing the signals on a hard drive or in memory), PDA with electronic media or other storage/player technology as will be developed. Once downloaded, the patient may connect the suitable player (e.g., MP3 player, CD player, DVD player, magnetic tape player, VCR, computer or PDA) to a suitable transducer and/or fluid filled headphones or a fluid filled neck ring, apply the transducer to the head or neck and/or put on the headphones or neck ring, and then play the file to obtain treatment.

Referring to FIG. 12, stimulus signals may be recorded and stored on a suitable recording media 500, which may be, for example, digital or analog magnetic tape, magnetic disc drives, optical disc (e.g., CD or DVD), solid state electronic memory (e.g., random access memory (RAM), flash memory or EPROM) or other storage/player technology that will be developed. The recording media 500 may be coupled to a computer 505, such as a network server computer, operating software that causes the recorded stimulus signals to be accessed from memory and converted into a format suitable for transmission via a telecommunications link. In an alternative implementation of this embodiment, the stimulus signals may be generated by the computer 505 in real time for communication via a telecommunications link instead of recording the stimulus signals prior to transmission. Computer 505 operates software and is configured to send and receive data via one or more telecommunication links, such as, by way of example but not by way of limitation, the Internet 510, telephone 515 (e.g., a T-1 line), a wireless link 525, a satellite communications link 535, and/or a cellular telephone link 570. Requests to the computer 505 for access to an individual's personalize stimulus signals may be received over the telecommunication link, with access controlled or limited by an individual's unique identifier and/or a password, and the stimulus signals may be sent in response thereto over the telecommunication link to a receiving device 530. Receiving device 530 is not limited to a particular type of device, and may be, for example, a desktop or laptop computer, PDA or other technology device that will be developed. Alternatively, the telecommunication link may connect to a cellular telephone 565 via cellular network 570. Stimulus signals received by the receiving device 530 may be saved in internal memory (e.g., random access memory (RAM)), on an internal hard drive, or to a portable recording media such as, for example, a removable magnetic data storage disc (e.g., as a floppy, “Zip” disc or removable hard drive), portable nonvolatile memory, random access memory (RAM) with power and/or refresh circuitry, optical memory (e.g., CD or DVD) (not shown) or other portable memory storage technology that will be developed in the future. The receiving device 130 then may be used to convert the stored stimulus signals into electronic signals that are sent to one or more treatment device, which may be fluid filled headphones 545, a fluid filled neck ring (not shown) and/or one or more transducers 555 via headphone cable 540 and/or transducer cable 550 or a wireless data link (not shown). Alternatively, the stimulus signals may be transferred to a portable recording/playing device 560, such as for example an MP3 player, which in turn is connected to treatment device, e.g., fluid filled headphones 545, a fluid filled neck ring (not shown) and/or one or more transducers 555 via headphone cable 540 and/or a transducer cable (not shown). In another configuration, the stimulus signals received by receiving device 530 are not recorded, and instead are transmitted in real time (e.g., as a streaming signal) to treatment device fluid filled headphones 545, a fluid filled neck ring (not shown) and/or one or more transducers 555 via headphone cable 540 and/or transducer cable 550 or a wireless data link (not shown). In the alternative configuration where signals are sent via a cellular telephone network 570, a cell phone 565 or similar device may be connected to fluid filled headphones 545, a fluid filled neck ring (not shown) and/or one or more transducers 555 via headphone cable 540 and/or transducer cable 550 or a wireless data link (not shown). In yet another configuration, cables 540, 550 may be replaced with a wireless link.

FIG. 12 depicts alternative system configurations that may be implemented simultaneously to enable the establishment of a central hearing loss treatment service in accordance with various embodiments of the present invention. Thus, while one individual may choose to receive stimulus signals via only one telecommunication path and receiving device, such as by means of a personal computer 530 connected to the Internet 510, a central treatment service may be configured to support all forms of telecommunications and all associated receiving devices. In such a system implementation, the central treatment service may offer a variety of forms of stimulus signals accessible by a variety of receiving devices over a variety of telecommunications paths, all of which may be individualized to provide treatments appropriate to each patient's particular hearing loss characteristics. An individual's hearing loss characteristics may be determined by testing with an audiometer to determine threshold hearing volumes at a variety of frequencies, which may be accomplished by a clinician (e.g., an audiologist) or automatically by means of an apparatus according to the present invention. This system would enable the same central treatment service to offer personalized stimulus signals to patients on all continents, with stimulus signals being transmitted via those telecommunications links that are accessible and available to each patient.

In a configuration of the systems and methods contemplated under this embodiment, treatment can be dispensed from a central treatment service over the Internet at the time and place chosen by a patient, audiologist or attending physician. In one configuration of this embodiment the patient may be required to pay a fee in return for receiving the treatment stimulus signal, such as by completing an electronic funds transfer or credit card transaction via an Internet website. This embodiment encompasses Internet-based pay-per-treatment access to stimulus signals and/or Internet-based on-line hearing loss treatment prescription fulfillment services, such as where the patient completes an Internet electronic payment of a fee (e.g., by completing a credit or debit card transaction) before receiving the treatment signal via the Internet. Alternatively, an Internet website allowing access to a vibration stimulus signal may monitor the duration that an individual accesses a stimulus signal and then generate an invoice based upon the duration of usage.

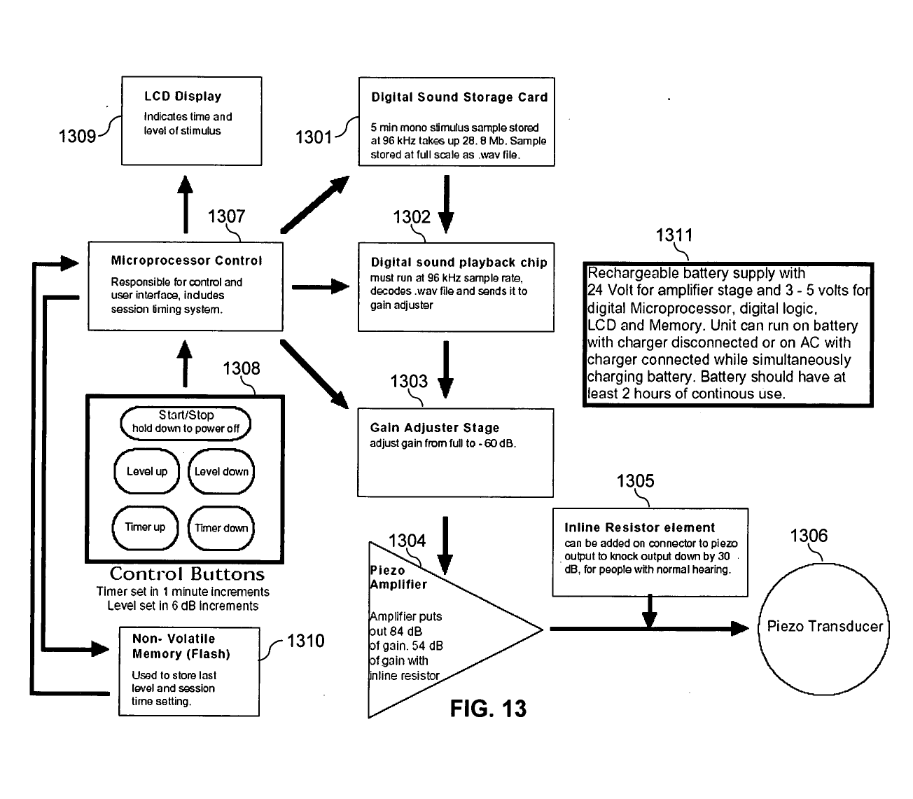

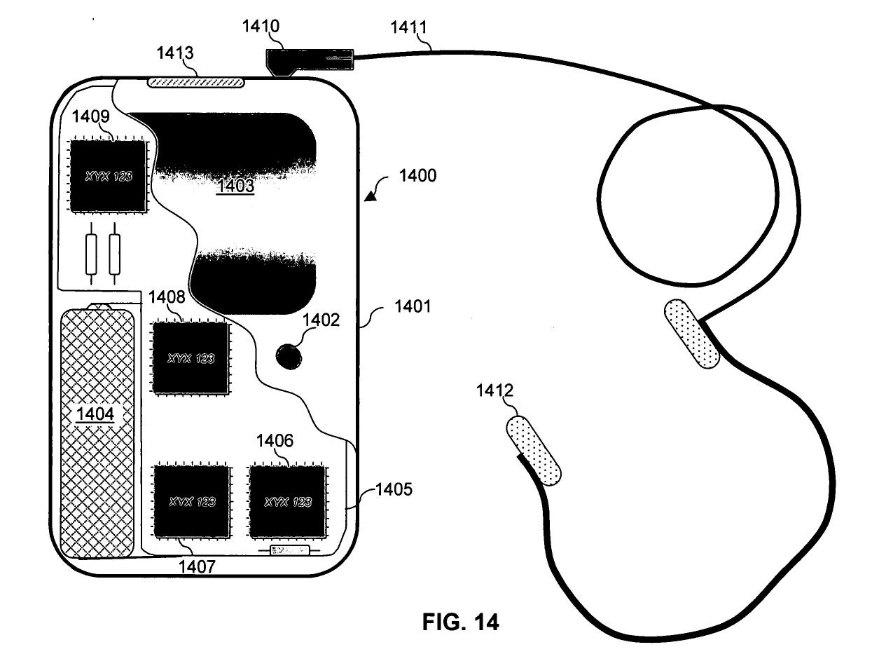

Another example embodiment of the present invention is illustrated in FIGS. 13 and 14. Referring to FIG. 13, in this embodiment, data representing the stimulus signals are recorded in a memory unit, such as a digital sound storage card 1301, which is coupled to a signal generator such as a digital sound playback chip 1302 which is coupled to a gain adjuster stage 1303 which is coupled to an amplifier 1304 which is coupled to a vibrator, such as a piezo transducer 1306. In an embodiment, an inline resistor element 1305 may be added to reduce the output of the piezo transducer 1306 by up to about 30 dB for use with individuals with normal hearing. A microprocessor 1307 controls the operation of the device, receiving user input via control buttons on a user input key pad 1308 and providing a display for a user via an LCD (or LED) display 1309. A non-volatile memory 1310, such as a flash memory, is coupled to the microprocessor for use in storing software instructions and/or data associated with operations, such as timing, parameter settings, user preferences, etc. The device is powered by a suitable power supply 1311, such as, for example, a replaceable battery, a rechargeable battery, fuel cell, photoelectric cell, or combination of two or more of such power sources. Specific embodiments of the power supply assembly 1311 include a compartment and electrical connections for receiving disposable batteries or rechargeable batteries, rechargeable batteries coupled to a power inlet to permit recharging, and photocells positioned on the exterior of the device and coupled electrically to rechargeable batteries. The power supply assembly 1311 may also include power conditioning circuitry (not shown) to control the output voltage and current, monitor the charge or output status, and/or manage recharging of rechargeable batteries. A suitable power supply assembly 1311 will provide the voltage required by the microprocessor and amplifier for a suitable amount of continuous use, a specific example of which is about 24 volts for the amplifier stage and 3-5 volts for the microprocessor, playback chip, digital logic, memory and LCD (or LED) display, for at least two hours of continuous use.

Since many of the components in this embodiment may be fabricated as integrated circuits, the auditory stimulator device can be assembled into a portable unit for convenient use by a patient. An example of such packaging is illustrated in FIG. 14. In this embodiment, the electronics of the auditory stimulator device 1400 are mounted in a functional and decorative housing 1401. Mounted on the exterior of the housing 1401 are user interface components, such as control buttons 1402 and a display 1403. Control buttons 1402 may be any suitable means for receiving input from a user known in the electronic arts, including by way of example but not by way of limitation, push buttons, rotatable knobs or switches, pressure sensitive pads, pads or zones sensitive to electrostatic or inductance changes when contacted by a finger or stylus, or other input technology that will be developed in the future. The display may be a liquid crystal display (LCD), light emitting diode (LED), plasma display or other suitable display technology that will be developed in the future. Optionally, the control buttons 1402 and display 1403 may be combined as a display and input component, such as a touch screen or stylus-activated screen, such the type of display/interface used in personal digital assistant devices. Within the housing 1401 are positioned a portable power supply, such as a battery 1404, and a circuit board 1405 on which various circuit elements are mounted and interconnected. The portable power supply used in the auditory stimulator device may be any of a removable battery 1404, rechargeable battery (which also may be removable), fuel cell, or other power supply technology that will be developed in the future. Components that may be coupled to the circuit board 1405 include, for example, a microcontroller or microprocessor 1408 which controls the functions of the auditory stimulator device 1400, one or more memory chips 1406, a signal generator module such as digital sound playback chip 1407, an amplifier/signal conditioning chip 1409 and various other electrical and signal conditioning components. In addition, the auditory stimulator device may include power conditioning and battery charging management circuitry (not shown). Output of the auditory stimulator device 1400 may be by means of an electrical connector 1410 that connects a vibrator, such as headphones 1412 or a fluid filled neck ring (not shown), by means of a cable 1411. Alternatively, the output may be provided to the vibrator by a wireless data link, such as for example a Bluetooth-compatible transmitter in the auditory stimulator device 1400 that transmits the output signal to a compatible Bluetooth enabled headphones 1412 or a fluid filled neck ring (not shown).

In addition to components required to generate the stimulus signal, the auditory stimulator device 1400 may include circuitry for transmitting data to and receiving data from an external computer. Such circuitry may include a wireless transmitter/receiver (transceiver) 1413, such as for example an infrared (1R) data link or radio frequency (RF) data link (e.g., for example, a Bluetooth or 802.11g wireless data link) as are well known in the electronic arts, or other wireless data communication technology or standard that will be developed in the future. In addition to the transmitter 1413, the auditory stimulator device may include circuitry (not shown) associated with the wireless transceiver for handling data communications tasks. A wireless transceiver 1413 enables the auditory stimulator device to receive configuration and personalizing data from a clinician, including a personalized stimulus signal and treatment profile, software updates from a clinician or manufacturer, music or language files that may be mixed with the stimulus signal or played alone (e.g., for entertainment), or data associated with other functions. A compatible transceiver coupled to a personal computer connected to the Internet would permit a user to send and receive data and software between remote sources (e.g., clinician or manufacturer servers) and the auditory stimulator device in a manner similar to that illustrated in FIG. 12. Other uses of a wireless transceiver on the auditory stimulator device are contemplated within the scope of the present invention.

A signal generator (e.g., a digital sound playback chip 1302, 1407) may be a custom chip containing circuitry configured to receive data from a stimulus data store and generate audio frequency signals consistent with the intended auditory stimulus treatment. Such a custom chip may comprise one or more digital signal processors, memory, signal conditioning circuits, amplifiers and other circuits as are well known in the electronic arts. Alternatively, a signal generator (e.g., digital sound playback chip 1302, 1407) may be one or more programmable digital signal processor chips as are commercially available, such as digital signal processor chips used in MP3 players. A signal generator based upon one or more programmable digital signal processors will operate with a sampling rate of about 96 kHz or more for generating stimulus signal frequencies in the range of about 21,000 Hz to about 42,000 Hz, and of about 44 kHz or more fore generating stimulus signal frequencies below about 21,000 Hz.

The foregoing description and FIG. 14 are intended as a nonlimiting example of a small-form packaging configuration of the present invention. Other packaging styles and designs are contemplated, including those enabled by advancements in integrated circuit fabrication and packaging technologies. For example, most of the components of a auditory stimulator device could be integrated within a single large scale integration (LSI) chip or within a few-chip set (e.g., a microcontroller chip coupled to a programmable digital signal processor chip) as such methods are well known in the LSI arts. Such a single/few chip implementation will permit more compact packaging configurations. One example embodiment of alternative packaging of the present invention integrates the auditory stimulator device components into a pair of eye glasses (e.g., sun glasses). In this packaging embodiment, circuitry and batteries may be positioned within the frames, and the vibrators (e.g., piezo transducers) may be positioned in the frames in the areas that rest on or near the ears. In another embodiment, the auditory stimulator device may be integrated into a package that can rest on the ear in a form similar to a hearing aid. It is contemplated that in time, advancements in integrated circuit technology may permit other configurations of the present invention.

In operation, a user of an auditory stimulator device as illustrated in FIG. 13 or 14 would apply the vibrator, such as piezo transducer 1306, headphones 1412 or a fluid filled neck ring (not shown), to the user's head and begin treatment by initiating a treatment program via control buttons 1308, 1402. A menu of various treatment options may be presented to the user on the display 1309, 1403 from which the user may make a selection. The user may also adjust certain parameters, such as volume or tone, using control buttons 1308, 1402. Having initiated the treatment, the user may then relax and listen to the stimulus.

As mentioned above, a first step in developing the treatment stimulation signal involves testing an individual to determine his/her hearing threshold profile. This may be accomplished by a clinician, such as an audiologist, using an audiometer. An audiometer is basically an audio frequency generator capable of generating periodic (e.g., sinusoidal) signals of controlled amplitude (i.e., volume) whose frequency ranges from about 125 Hz to about 20000 Hz suitable for driving headphones to produce sounds in that frequency range. Typically, the individual being tested wears headphones to listen to the generated tones, and presses a button when he/she hears each tone. Typically, testing is accomplished at a number of discrete frequencies across the audible range, such as, for example, 250, 500, 1000, 2000, 3000, 4000, 6000 and 8000 Hz. The amplitude (i.e., volume) of each tone is raised and lowered in response to the individual pressing a button when each tone is perceived in order to determine a hearing threshold or hearing level (HL) for that tone. This process is repeated in each ear and for each tone and then graphed to provide a hearing level profile. An example hearing level profile is illustrated in FIG. 9.

While human hearing extends up to about 20,000 Hz, testing of the hearing levels above about 8000 Hz is rarely conducted due to the acoustical interference that occurs in the ear canal at high frequencies. Acoustical interference results from the size and shape of the ear canal, occurring when the frequency of a tone is such that one-fourth of the tone's wavelength is similar to the length of the ear canal. Such interference reduces the amplitude of high frequency sound reaching the ear drum in an unpredictable manner, and making it nearly impossible to accurately measure hearing thresholds by air conduction audiometric methods.

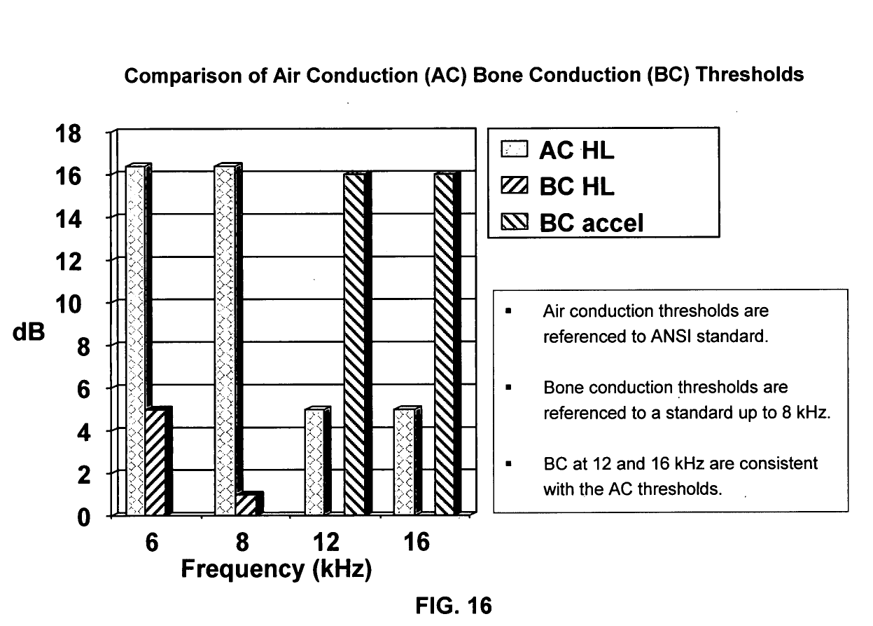

According to an embodiment of the present invention, the difficulties in testing individuals at high frequencies can be overcome by utilizing a piezo transducer applied to the neck or head to supply the test signals via bone conduction. This method bypasses the outer and middle ear and applies the vibration directly to the inner ear. A comparison of the air conduction and bone conduction hearing level (HL) thresholds of a typical individual are illustrated in FIG. 16. Hearing Loss (HL) is an American National Standards Institute (ANSI) standards term. There exists no standards above 8 kHz for bone conduction testing, so acceleration mass load to the head (“BC accel”) is used. Calibration of bone conduction in the audiometric range may be based on measurement of acceleration and forces using an artificial mastoid with extension of the measurement to the high audio range using a live head as disclosed in “Measurement of Bone Conduction Levels for High Frequencies,” M. Lenhardt, et al., International Tinnitus Journal, Vol. 8, No. 1&2, 2002, pp. 9-12, the contents of which are incorporated by reference in their entirety. As can be seen, the hearing level thresholds typically decline at 12000 and 16000 Hz from that typical at 6000 and 8000 Hz due to ear canal interference. However, when hearing level thresholds are tested using bone conduction with acceleration mass load to the head (BC accel), comparable hearing thresholds are achieved. Thus, it should be expected that standards for hearing thresholds at high frequency based on air conduction testing inherently include the effects of ear canal interference as well as natural acuity. Such differences in conduction should be considered when using bone conduction to test for high frequency hearing level thresholds.

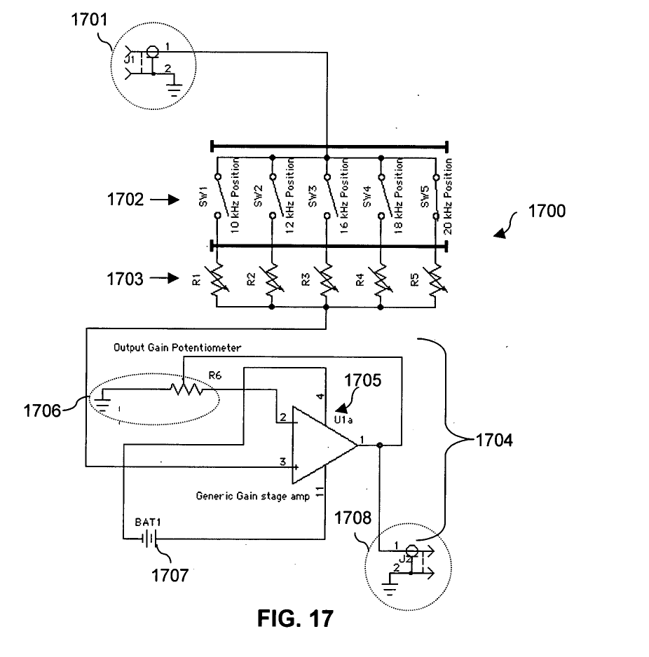

For frequencies in the range of about 6000 to about 8000 Hz, the output of some audiometers may be supplied directly to the transducer. However, for hearing level testing at higher frequencies, driving the transducer directly will not yield reliable results due to the differences in sound conduction to the ear drum via air (air conduction) and bone (bone conduction) at such frequencies. To accommodate this difference in conduction, an embodiment of the present invention provides a matching circuit 1700, a nonlimiting example of which is illustrated in FIG. 17, to adjust the amplitude of the applied signal at each test frequency. This matching circuit 1700 enables testing of an individual's high frequency hearing levels using bone conduction and a standard audiometer.

Referring to FIG. 17, the example embodiment of the matching circuit 1700 includes inputs 1701 to receive the high frequency output from an audiometer which are coupled to a switch array 1702 made up of a plurality of switches SW1 through SW5, one for each frequency at which hearing levels are to be tested. Switch array 1702 may be a rotary, push button, digital or other suitable switch configured so only one switch can be closed at a time. A variable resistor (e.g., a tripot) R1 to R5 is coupled to each switch SW1-SW5, forming a resistor array 1703. Each resistor R1-R5 serves to adjust the gain in the signal so as to compensate for the greater coupling between the transducer and the inner ear via bone conduction compared to air conduction, resulting in approximately the same energy reaching the inner ear by bone conduction as would occur by air conduction. The output of each resistor R1-R5 may be connected to a gain adjustment circuit 1704 to permit an operator to adjust the output signal strength, such as by turning a knob. A nonlimiting example of a gain adjustment circuit 1704 includes an amplifier 1705 with an input coupled to the output of the resistor array 1703, and the output and a second input coupled to a potentiometer 1706. Voltage may be supplied to the amplifier 1705 by a voltage source or power supply, such as a battery 1707. Adjusting the potentiometer permits control of the amplifier 1705 output which is coupled to output connectors 1708. Output connectors 1708 are suitable for connecting to the input of a piezo amplifier and/or piezo transducer.

The variable resistors may be adjusted during a calibration procedure for a particular audiometer or make/model of audiometer. The appropriate resistance can be determined by measuring the energy reaching the inner ear for each frequency by both air and bone conduction and calculating the ratio between the measured values. Quality reference standards may be established for bone conduction at selected frequencies, such as for example 12,000 and 16,000 Hz, which relate to air calibration standards for those frequencies.

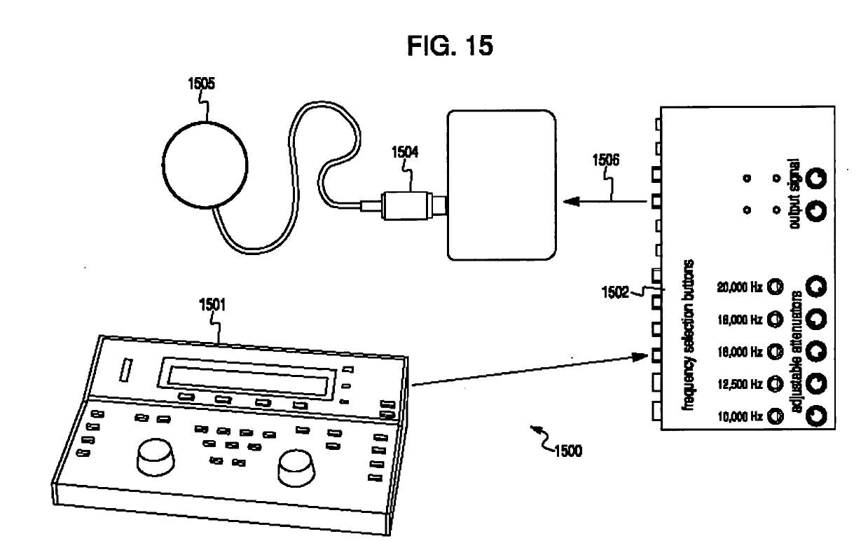

In another embodiment of the present invention, the output 1708 of the matching circuit 1700 may be connected to the input of an auditory stimulator system according to the various embodiments of the present invention. This configuration is illustrated in FIG. 15, which shows an audiometer system 1500 made up of a signal generator 1501, such as from a standard audiometer, coupled to a matching circuit assembly 1502, that provides an output 1506 to an auditory stimulator 1503, which is coupled via a cable 1504 to a piezo transducer 1505 or other suitable vibrator. In this manner, the auditory stimulator system can serve as part of the testing equipment as well as the treatment system. Using the auditory stimulator 1503 to conduct testing of an individual's hearing level thresholds offers advantages in terms of cost and calibration. Using the individual's auditory stimulator saves on the cost of headphones and other equipment, which may require sterilization between tests. Also, this embodiment may permit calibrating the auditory stimulator one time for both testing and treatment, and permit more precise treatment levels.

In a further embodiment, the signal generator functions of an audiometer may be combined with or incorporated into the functionality of the auditory stimulator itself. For example, the frequency and amplitude control circuitry of an audiometer can be implemented within a single integrated circuit (an “audiometer chip”) that can function in conjunction with other components of the auditory stimulator device to permit the device to function as an audiometer using some or all of the components associated with the stimulator functionality. Additional memory or amplifier chips necessary to accomplish audiometer functions may also be incorporated into the auditory stimulator device circuitry. Optionally, the audiometer chip may be packaged as an external module, such as for example a PCMCI card or external module with a USB or Firewire connector, that can be plugged into an auditory stimulator device to permit it to also (or alternatively) function as an audiometer. User input to indicate perception of a test sound may be provided by pressing one or more control buttons on the input key pad (e.g., key pad 1308 in FIG. 13), such as one key to indicate sound perception in the left ear and another key to indicate sound perception in the right ear. Further, the display of the auditory stimulator (e.g., LCD display 1309 in FIG. 13) may present instructions to assist the user in testing his/her own hearing. Special audiometer function software operating within the audiometer chip or in the microprocessor of the auditory stimulator device may change the functions of control buttons and display user functions on the LCD or LED while the audiometer function is enabled. Results of the hearing level testing may be stored temporarily in memory and then displayed on the device (e.g., on LCD display 1309 in FIG. 13) and/or transmitted to a clinician's equipment via a communication link (e.g., a wireless communications link 1413 in FIG. 14).

As a further alternative configuration of this embodiment, the audiometer function may be accomplished by an audiometer software module capable of running on the microprocessor in the auditory stimulator device, where the audiometer software module instructions cause the microprocessor to direct or control digital signal processors in the device to perform the functions of an audiometer chip. Digital signal processors may be employed in the device for generating the stimulation therapy, such as in the digital sound playback chip 1302 illustrated in FIG. 13. In this alternative, an audiometer function software module would cause the digital signal processors to produce tones of the desired testing frequencies at control the output volume as appropriate to conduct hearing level threshold testing, as well as alter the functions of control keys and the display. This configuration may require additional nonvolatile memory to store the audiometer function software module, but would obviate the need for a separate audiometer chip and related electronics.

In addition to incorporating the audiometer function into the auditory stimulator, additional functionality may be implemented by software to enable the device to calculate a personalized auditory stimulation treatment based upon the results of the hearing level testing. Operating such software, the microprocessor would perform suitable algorithms on test results data stored in memory to produce the appropriate stimulus signals, and then store those signals for use during treatments.

Combining the audiometer function into the auditory stimulator device enables several benefits to clinicians and users. A combined device would eliminate the need for expensive and bulky audiometers, enabling a clinician to offer less expensive services or treat individuals in their home or in remote locations. A combined device may also permit more accurate treatments since the same electronics and transducers are used to test hearing thresholds and to provide stimulation therapies. A combined device would permit individuals to monitor their own hearing levels, track improvements in their hearing, and otherwise participate in their treatment. A combined device would permit connecting clinicians to their patients via electronic networks, such as the Internet, an intranet or a wireless fidelity (WiFi) network, since the patient's device contains both the testing and treatment equipment, and it may configured to communicate test results and other parameters to the clinician via the network (e.g., by communicating with a computer connected to the Internet). A combined device may also permit detection and treatment of hearing loss without the participation of a trained clinician, such as may be appropriate in remote areas and lesser-developed countries.

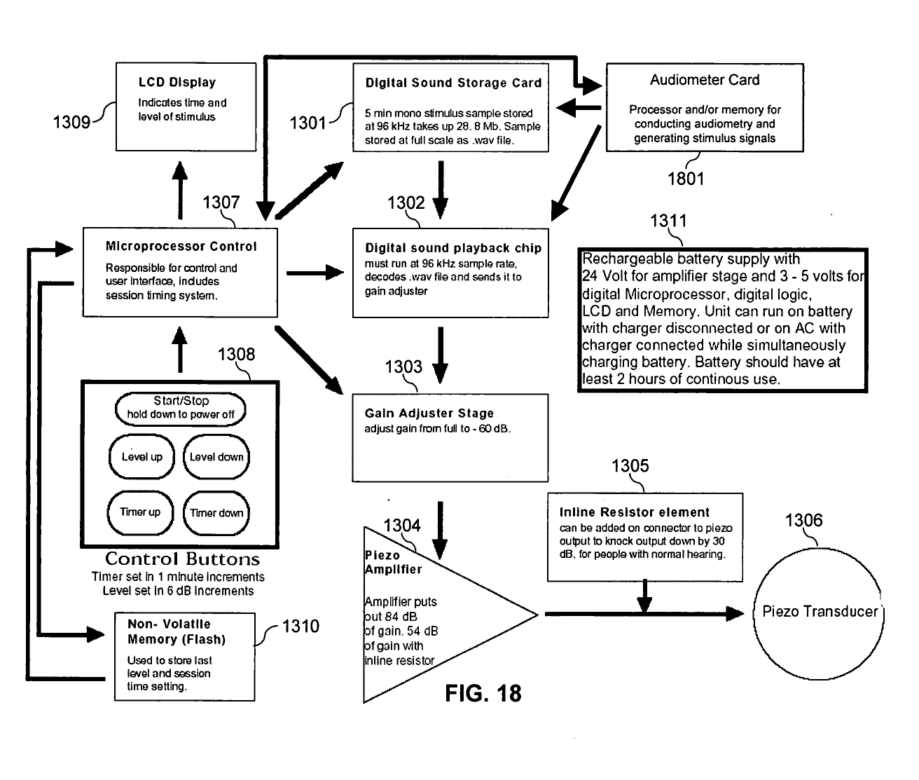

A block diagram of a combined audiometer/auditory stimulator device is illustrated in FIG. 18. This diagram includes the same components as illustrated in FIG. 13 with the same reference numerals, and reference should be made to the description of such components provided herein with respect to that figure. Additionally, an audiometer chip 1801 is coupled to the microprocessor 1307 to perform the audiometer functions and, optionally, to the signal generator (e.g., digital sound playback chip 1302) to provide the test signals to be presented to the user via the piezo transducer 1306. As discussed above, the audiometer chip 1801 may not be a separate chip, but may be a separate function or software module implemented within the microprocessor 1307.

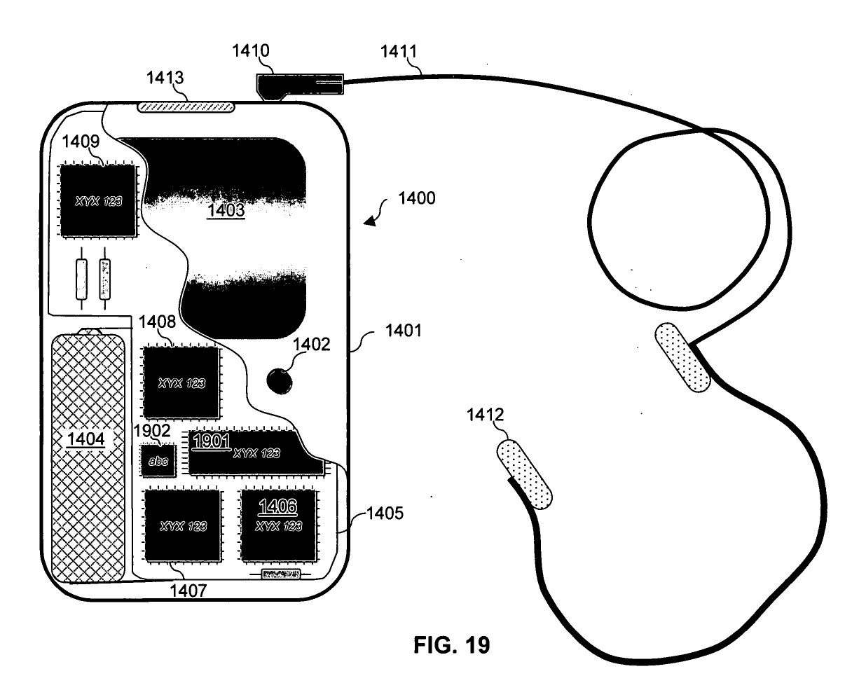

An illustration of an embodiment of a combined audiometer/auditory stimulator device is provided in FIG. 19. This illustration includes the same components as illustrated in FIG. 14 with the same reference numerals, and reference should be made to the description of such components provided herein with respect to that figure. Additionally, an audiometer chip 1901 is coupled to the circuit board 1405 to provide the audiometer functions. Additional components may also be coupled to the circuit board 1405, such as, for example, additional memory 1902, as necessary to provide a suitable test signal, provide additional software instructions, and/or store test results data. An alternative of this configuration would include a socket (not shown) coupled to the circuit board 1405 and a slot in the case 1401 for accepting an audiometer chip as a plug-in module. An alternative configuration in which an audiometer software module is used to provide audiometer functionalility would be configured much like FIG. 14, perhaps with an additional memory chip 1902 to accommodate the additional software and/or test data.

In operation, a user of a combined audiometer/auditory stimulator device 1300, 1400 may activate the audiometer function by selecting an option via the key pad 1308, 1402. In response, a script may be presented on the display 1309, 1403 providing the user with instructions for conducting the test. This may involve placing the vibrator, such as piezo transducer 1306, headphones 1412 or a fluid filled neck ring (not shown), on the user's head or neck, and initiating the test by pressing an appropriate button. During the test, the user listens for tones and presses an appropriate key pad button 1308, 1402 whenever a tone is perceived. Software within the device varies the volume presented for each tone and for each ear until the user has provided threshold hearing indications for all test tones. At this point, the results may be displayed, such as in numerical or graphical form, on the display 1309, 1403. Test results may be communicated to a clinician, such as via a communication link 1413 connected to a suitable communication device, such as a personal computer connected to the Internet. The clinician may then determine a suitable, personalized treatment stimulus and communicate it to the device, such as via the communication link 1413, for storage in a memory chip 1406 or digital sound storage card 1301. Alternatively, the microprocessor 1307, 1408 may perform an algorithm to generate suitable, personalized treatment stimulus and store it in a memory chip 1406 or digital sound storage card 1301. Having completed the hearing level test, the user may then operate the device to provide auditory stimulation as described above.

An integrated audiometer/auditory stimulator device may also incorporate additional features and functions to provide effective treatment. For example, the device may incorporate circuitry to permit it to self calibrate, thereby ensuring that the test and treatment signals are provided at the proper frequencies and volumes. A self calibration circuitry may comprise an oscillator circuit that produces a known acceleration output or force level positioned within the device and switched on to check the calibration of the transducer. A visual display and an output adjustment circuit or user input may also be provided as part of the calibration circuit and functionality. As another example, an auditory stimulator device may also be used for entertainment, such as to play music, when treatment is not being applied.

The foregoing description of various embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

1. A method for improving the hearing and discrimination of an individual, comprising:
placing a transducer on a head or neck of the individual; and
providing a vibration signal to the transducer so as to apply a vibration stimulus having at least one frequency between about 2 kHz and 5 MHz to the individual for a period of time.

2. The method for improving the hearing and discrimination of an individual according to claim 1, wherein the vibration stimulus is applied via a piezo transducer placed in direct contact with one or both of the head and neck of the individual.

3. The method for improving the hearing and discrimination of an individual according to claim 1, wherein the at least one frequency of the vibration stimulus is in the range of between about 2 kHz and about 200 kHz.

4. The method for improving the hearing and discrimination of an individual according to claim 1, wherein the at least one frequency of the vibration stimulus is in the range of between about 2 kHz and about 20 kHz.

5. The method for improving the hearing and discrimination of an individual according to claim 1, wherein the at least one frequency of the vibration stimulus is in the range of between about 50 kHz and about 5 MHz.

6. The method for improving the hearing and discrimination of an individual according to claim 1, wherein the transducer is positioned within a fluid that is in contact with the head of the individual.

7. The method for improving the hearing and discrimination of an individual according to claim 6, wherein the fluid is contained within a membrane and the membrane is placed in direct contact with the head of the individual.

8. The method for improving the hearing and discrimination of an individual according to claim 1, further comprising periodically repeating the step of applying a vibration stimulus to the individual for a period of time.

9. The method for improving the hearing and discrimination of an individual according to claim 1, wherein the method is applied to the individual does not have tinnitis.

10. The method for improving the hearing and discrimination of an individual according to claim 1, wherein the vibration stimulus comprises a first vibration having a first frequency modulated by a second vibration having a second frequency which is audible.

11. The method for improving the hearing and discrimination of an individual according to claim 10, wherein the second vibration comprises music.

12. The method for improving the hearing and discrimination of an individual according to claim 11, wherein the vibration stimulus is recorded as a vibration stimulus signal on a recording media which is playable on a suitable device to produce the vibration stimulus applied to the individual.

13. The method for improving the hearing and discrimination of an individual according to claim 1, wherein the vibration stimulus is accessed via the Internet.

14. The method for improving the hearing and discrimination of an individual according to claim 13, wherein the vibration stimulus is accessible at a website and further comprising accessing the website and downloading the vibration stimulus.

15. The method for improving the hearing and discrimination of an individual according to claim 13, further comprising paying a fee prior to downloading the vibration stimulus.

16. A method of treating an individual having partial sensorineural hearing loss, comprising:
applying a transducer to the individual's head or neck; and
supplying a first vibration stimulus signal to the transducer so as to provided a first vibration stimulus having at least one frequency to the individual for a period of time.

17. The method of treating an individual having partial sensorineural hearing loss according to claim 16, further comprising
applying fluid filled headphones to the individual; and
supplying a second vibration stimulus signal having at least one frequency to the fluid filled headphones for the period of time.

18. The method of treating an individual having partial sensorineural hearing loss according to claim 16, wherein the at least one frequency of the first vibration stimulus is in the range of between about 1 Hz and about 200 kHz.

19. The method of treating an individual having partial sensorineural hearing loss according to claim 16, wherein the at least one frequency of the first vibration stimulus is a high frequency in the range of between about 2 kHz and about 20 kHz.

20. The method of treating an individual having partial sensorineural hearing loss according to claim 16, wherein the at least one frequency of the first vibration stimulus is an ultrasound frequency in the range of between about 50 kHz and about 5 MHz.

21. The method of treating an individual having partial sensorineural hearing loss according to claim 17, wherein the at least one frequency of the second vibration stimulus signal is a high frequency in the range of about 2 kHz and 200 kHz.

22. The method of treating an individual having partial sensorineural hearing loss according to claim 16, wherein the first vibration stimulus is applied via a piezo transducer placed on one or both of a head and neck of the individual.

23. The method of treating an individual having partial sensorineural hearing loss according to claim 17, wherein the at least one frequency of the first vibration stimulus applied to the head of the individual is a first frequency in the ultrasound range and the at least one frequency of the second vibration stimulus signal applied to the headphones is a second frequency in the high frequency range.

24. The method of treating an individual having partial sensorineural hearing loss according to claim 17, further comprising periodically repeating the step of applying a vibration stimulus to the individual for a period of time.

25. The method of treating an individual having partial sensorineural hearing loss according to claim 16, wherein the method of treating is applied to an individual who does not have tinnitis.

26. A method of treating an individual having partial sensorineural hearing loss, comprising:
applying fluid filled headphones to the individual; and
supplying a vibration stimulus signal having at least one frequency between about 2 kHz and about 20 kHz to the fluid filled headphones for a period of time.

27. The method of treating an individual having partial sensorineural hearing loss according to claim 26, wherein the vibration stimulus signal comprises a high frequency signal modulated by an audible frequency signal.

28. The method of treating an individual having partial sensorineural hearing loss according to claim 26, wherein the audible frequency signal comprises music.

29. The method of treating an individual having partial sensorineural hearing loss according to claim 26, wherein the vibration stimulus signal is recorded on a recording media that is connected to the fluid filled headphones and played by a suitable device.

30. The method of treating an individual having partial sensorineural hearing loss according to claim 26, wherein the individual does not have tinnitis.

31. The method for improving the hearing of an individual according to claim 26, further comprising:
accessing an Internet website; and
downloading the vibration stimulus signal.

32. The method for improving the hearing and discrimination of an individual according to claim 31, further comprising paying a fee prior to downloading the vibration stimulus signal.

33. A method of providing a treatment for an individual having partial sensorineural hearing loss, comprising:
storing a vibration stimulus signal on a recording medium; and
allowing access to the stored vibration stimulus signal so that the vibration stimulus signal can be applied to a transducer.

34. The method of providing a treatment for an individual having partial sensorineural hearing loss according to claim 33, wherein allowing access to the stored vibration stimulus signal is accomplished by allowing access to an Internet website.

35. The method of providing a treatment for an individual having partial sensorineural hearing loss according to claim 34, further comprising accepting an electronic payment of a fee prior to allowing access to the stored vibration stimulus signal.

36. The method of providing a treatment for an individual having partial sensorineural hearing loss according to claim 33, wherein access to the stored vibration stimulus signal comprises providing the individual a compact disk having the vibration stimulus signal stored thereon.

37. The method of providing a treatment for an individual having partial sensorineural hearing loss according to claim 33, wherein access to the stored vibration stimulus signal comprises permitting the individual to load the vibration stimulus signal onto an MP3 player.

38. A system for treating hearing loss by means of a vibration stimulus provided to the head or neck of a patient, comprising:
a computer operating executable instructions that cause the computer to produce stimulus signals suitable for transmission;
a receiving device configured to receive stimulus signals;
a two-way telecommunications link coupled to the computer and to the receiving device, the two-way telecommunications link configured to communicate stimulus signals; and
a treatment device coupled to the receiving device to receive stimulus signals and configured to convert stimulus signals into vibration stimulus and apply the vibration stimulus to one or both of the head and neck of the patient.

39. The system for treating hearing loss according to claim 38, further comprising a storage medium having stimulus signals recorded thereon coupled to the computer, wherein the storage medium is configured to communicate the recorded stimulus signals to the computer and the executable instructions cause the computer to use the communicated recorded stimulus signals to produce stimulus signals suitable for transmission.

40. The system for treating hearing loss according to claim 38, wherein the receiving device is a computer.

41. The system for treating hearing loss according to claim 38, wherein the receiving device is a cellular telephone.

42. The system for treating hearing loss according to claim 38, wherein the receiving device stores received stimulus signals on a recording medium.

43. The system for treating hearing loss according to claim 42, wherein the recording medium is a compact disc.

44. The system for treating hearing loss according to claim 38, wherein the telecommunication link comprises a computer network.

45. The system for treating hearing loss according to claim 38, wherein the telecommunication link comprises a telephone network.

46. The system for treating hearing loss according to claim 38, wherein the telecommunication link comprises a wireless communications link.

47. The system for treating hearing loss according to claim 38, wherein the treatment device comprises a transducer configured to be placed in direct contact with the head or neck of the patient.

48. The system for treating hearing loss according to claim 38, wherein the treatment device comprises:
a housing;
a fluid containing membrane coupled to the housing;
a fluid contained within the membrane; and
a transducer coupled to the housing and vibrationally coupled to the fluid.

49. The system for treating hearing loss according to claim 48, wherein the treatment device is fashioned in the form of headphones.

50. The system for treating hearing loss according to claim 48, wherein the treatment device is fashioned in the form of a neck ring.

51. The system for treating hearing loss according to claim 49, wherein the treatment device further comprises a transducer configured to be placed in direct contact with the head or neck of the patient.

52. The system for treating hearing loss according to claim 38, wherein the computer and the receiving device are located in different physical locations.

53. Fluid filled headphones suitable for use in treating hearing loss, comprising:
a pair of fluid filled phones, each comprising:
a housing;
a fluid containing membrane coupled to the housing so as to contain a fluid;
a fluid contained within the membrane; and
a transducer coupled to the housing and vibrationally coupled to the fluid; and
a U-shaped bracket coupled to each of the pair of fluid filled phones and configured to position each of the pair of fluid filled phones in contact with a head of an individual when worn.

54. A fluid filled neck ring suitable for use in treating hearing loss, comprising:
a housing;
a fluid containing membrane coupled to the housing so as to contain a fluid and configured in a form suitable for fitting partially around a neck of an individual;
a fluid contained within the membrane; and
a transducer coupled to the housing and vibrationally coupled to the fluid.

55. A device for use by an individual for treating hearing loss by applying a stimulus signal to the individual, comprising:
a memory configured to store stimulus signal data representing the stimulus signal to be applied;
a signal generator coupled to the memory and configured to generate a signal based upon the stimulus signal data; and
a vibrator coupled to the signal generator and configured to be positioned on an individual to provide a vibration stimulus to the individual,
wherein the vibration stimulus has at least one frequency between about 2 kHz and 5 MHz.

56. The device according to claim 55, further comprising a portable power supply.

57. The device according to claim 56, wherein the portable power supply is removeable.

58. The device according to claim 56, wherein the portable power supply comprises at least one of a disposable battery, a rechargeable battery, a fuel cell, and a photoelectric cell.

59. The device according to claim 55, further comprising:
a microprocessor coupled to the signal generator and configured to operate software instructions stored in a second memory;
a keypad coupled to the microprocessor; and
a display coupled to the microprocessor.

60. The device according to claim 59, further comprising:
an audiometer module coupled to at least one of the signal generator, the microprocessor and the vibrator, wherein the audiometer module is configured to generate signals suitable for testing a hearing level threshold of the individual.

61. The device according to claim 59, wherein the software instructions comprise an audiometer function module configured to cause the microprocessor to direct the signal generator to generate signals suitable for testing a hearing level threshold of the individual.

62. The device according to claim 61, wherein the audiometer function module causes the microprocessor to accept an input from the individual indicating perception of a vibration signal during testing of a hearing level threshold of the individual.

63. The device according to claim 59, wherein the software instructions include a module configured to cause the microprocessor to generate a stimulus signal for treating the individual for hearing loss based upon results of a hearing level threshold testing of the individual.

64. The device according to claim 62, wherein the software instructions include a module configured to cause the microprocessor to generate a stimulus signal for treating the individual for hearing loss based an input from the individual indicating perception of a vibration signal during testing of a hearing level threshold of the individual.

65. A device for treating hearing loss of an individual, comprising:
memory means for storing data representative of a stimulus signal;
means for generating a stimulus signal based on the data representative of the stimulus signal; and
means for applying the stimulus signal as a vibration stimulus to one or both of the head and neck of the individual,
wherein the vibration stimulus has at least one frequency between about 2 kHz and 5 MHz.

66. A device for connecting an audiometer to a piezo transducer to enable testing hearing level thresholds of individuals in a high frequency range, comprising:
an input configured to receive an output signal from the audiometer;
a switch array electrically coupled to the input, the switch array comprising a plurality of switches configured so that at most one switch in the array can be closed at a time;
a resistor array comprising a plurality of resistors each coupled to one of the plurality of switches and configured to provide a resistance suitable for adjusting a gain of a particular frequency output signal from the audiometer to compensate for a difference in conduction of sound at the particular frequency through bone as compare to through air; and
an output connector electrically coupled to the resistor array and configured to be connectable to a piezo transducer.

67. The device according to claim 66, further comprising:
an amplifier having a first input electrically coupled the resistor array and an output electrically coupled to the output connector; and
a potentiometer coupled between a second input and to the output of the amplifier.
